(19) United States
(12) Patent Application Publication
(10) Pub. No.: US 2023/0221569 A1
(43) Pub. Date: Jul. 13, 2023

(54) VIRTUAL IMAGE DISPLAY DEVICE AND DISPLAY SYSTEM

(71) Applicant: DENSO CORPORATION, Kariya-city (JP)

(72) Inventors: Kohji OHYAMA, Kariya-city (JP); Yuji KAWAHARA, Kariya-city (JP); Masanao HIGUCHI, Kariya-city (JP); Yoichi NARUSE, Kariya-city (JP); Masayuki YAMAGUCHI, Kariya-city (JP)

(21) Appl. No.: 18/175,015

(22) Filed: Feb. 27, 2023

Related U.S. Application Data
(63) Continuation of application No. PCT/JP2021/036082, filed on Sep. 30, 2021.

(30) Foreign Application Priority Data
Oct. 16, 2020 (JP) 2020-174732
Sep. 15, 2021 (JP) 2021-150313

(51) Int. Cl. G02B 27/01; G09G 3/00; B60K 35/00; G08G 1/16; G08G 1/14; G01C 21/36

(52) U.S. Cl. CPC G02B 27/0179; G09G 3/002; B60K 35/00; G08G 1/16; G08G 1/14; G01C 21/365; G02B 27/0101; G09G 2340/0464; G09G 2380/10; G02B 2027/0141

(57) ABSTRACT

A virtual image display device includes: a switching mechanism for switching a position of a view angle including a first position and a second position; and a display control unit for displaying the virtual image in response to a switching of the position of the view angle by the switching mechanism. When the display control unit displays a specific content within the view angle at the second position after the switching mechanism switches the view angle from the first position to the second position, the display control unit starts displaying a related content preliminarily associated with the specific content before the switching of the view angle to the second position is completed.

### CROSS REFERENCE TO RELATED APPLICATIONS

The present application is a continuation application of International Patent Application No. PCT/JP2021/036082 filed on Sep. 30, 2021, which designated the U.S. and claims the benefit of priority from Japanese Patent Applications No. 2020-174732 filed on Oct. 16, 2020 and No. 2021-150313 filed on Sep. 15, 2021. The entire disclosures of all of the above applications are incorporated herein by reference.

### TECHNICAL FIELD

The disclosure herein relates to a virtual image display device and a display system that displays a virtual image viewable by a vehicle occupant.

### BACKGROUND

A conceivable technique shows a head-up display device having an adjustment mechanism for mechanically shifting a projection range in which light of a display image to be displayed as a virtual image is projected. This head-up display device shifts the position of the projection range by means of an adjustment mechanism as scene adaptation control so that the entire display object with a high priority is displayed.

### SUMMARY

According to an example, a virtual image display device may include: a switching mechanism for switching a position of a view angle including a first position and a second position; and a display control unit for displaying the virtual image in response to a switching of the position of the view angle by the switching mechanism. When the display control unit displays a specific content within the view angle at the second position after the switching mechanism switches the view angle from the first position to the second position, the display control unit starts displaying a related content preliminarily associated with the specific content before the switching of the view angle to the second position is completed.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram for explaining a virtual image display function of a HUD according to a first embodiment;

FIG. 2 is a block diagram showing an electrical configuration of a display system;

FIG. 3 is a diagram showing an example of a lookup table;

FIG. 4 is a diagram showing the details of display transition when the view angle position is shifted;

FIG. 5 is a diagram showing an example of display at the normal position when lane departure warning is performed;

FIG. 6 is a diagram showing an example of a display during a period of view angle shift from a normal position to a superimposed position when the lane departure warning is performed;

FIG. 7 is a diagram showing an example of display at the superimposed position when the lane departure warning is performed;

FIG. 8 is a diagram showing another example of the display during the period of the view angle shift when lane departure warning is performed;

FIG. 9 is a diagram showing another example of display at the superimposed position when the lane departure warning is performed;

FIG. 10 is a diagram showing another example of the display during the period of the view angle shift when lane departure warning is performed;

FIG. 11 is a diagram showing an example of display at the normal position when notifying a change in the status of an adaptive cruise control;

FIG. 12 is a diagram showing an example of a display during a period of view angle shift from the normal position to the superimposed position when a status change in the adaptive cruise control is notified;

FIG. 13 is a diagram showing an example of display at the superimposed position when notifying a change in the status of an adaptive cruise control;

FIG. 14 is a diagram showing another example of the display during the period of the view angle shift when notifying a status change in the adaptive cruise control;

FIG. 15 is a diagram showing another example of display at the superimposed position when notifying a status change in an adaptive cruise control;

FIG. 16 is a diagram showing another example of the display during the period of the view angle shift when notifying a status change in the adaptive cruise control;

FIG. 17 is a diagram showing another example of display at the superimposed position when notifying a status change in an adaptive cruise control;

FIG. 18 is a diagram showing another example of the display during the period of the view angle shift when notifying a status change in the adaptive cruise control;

FIG. 19 is a diagram showing another example of display at the superimposed position when notifying a status change in an adaptive cruise control;

FIG. 20 is a diagram showing an example of display at a normal position of a turn-by-turn for route guidance;

FIG. 21 is a diagram showing an example of a display during a period of view angle shift from a normal position to a superimposition position in turn-by-turn;

FIG. 22 is a diagram showing an example of display at a superimposed position of the turn-by-turn;

FIG. 23 is a diagram showing another example of display at a superimposed position of the turn-by-turn;

FIG. 24 is a diagram showing another example of display at a superimposed position of the turn-by-turn;

FIG. 25 is a diagram showing another example of display at a superimposed position of the turn-by-turn;

FIG. 26 is a diagram showing an example of traffic sign recognition support display when the view angle is at the normal position;

FIG. 27 is a diagram showing an example of the traffic sign recognition support display after the view angle has shifted to the superimposed position;

FIG. 28 is a diagram showing an example of traffic sign recognition support display after the view angle returns to the normal position;

FIG. 29 is a diagram showing another example of the traffic sign recognition support display after the view angle has shifted to the superimposed position;

FIG. 30 is a diagram showing another example of the traffic sign recognition support display after the view angle has shifted to the superimposed position;

FIG. 31 is a diagram showing another example of the traffic sign recognition support display after the view angle has shifted to the superimposed position;

FIG. 32 is a flowchart showing details of display control process performed by a head-up ECU;

FIG. 33 is a flowchart showing details of display control process performed by a meter ECU;

FIG. 34 is a block diagram showing the electrical configuration of the display system according to the second embodiment;

FIG. 35 is a diagram showing an example of a view angle position defined for the HUD and a content displayed at each view angle position according to the second embodiment;

FIG. 36 is a block diagram showing the electrical configuration of the display system according to the second embodiment;

FIG. 37 is a diagram showing an example of a display during a period of view angle shift from a normal position to a superimposed position when a forward obstacle warning is performed;

FIG. 38 is a diagram showing an example of display at the superimposed position when the forward obstacle warning is performed;

FIG. 39 is a diagram showing an example of display at the normal position when parking space guidance is performed;

FIG. 40 is a diagram showing an example of display during a period of view angle shift from the normal position to the superimposed position when parking space guidance is performed;

FIG. 41 is a diagram showing an example of display at the superimposed position when the parking space guidance is performed;

FIG. 42 is a diagram showing an example of display during a period of view angle shift from the superimposed position to the normal position when the parking space guidance is performed;

FIG. 43 is a diagram showing an example of display at the normal position when narrow road driving support display is performed;

FIG. 44 is a diagram showing an example of a display during a period of view angle shift from the normal position to the superimposed position when the narrow road driving support display is performed;

FIG. 45 is a diagram showing an example of display at the superimposed position when narrow road driving support display is performed;

FIG. 46 is a diagram showing an example of the narrow road driving support display after the position of the view angle is returned to the normal position;

FIG. 47 is a diagram showing an example of display at the normal position when visibility support display is performed;

FIG. 48 is a diagram showing an example of a display during a period of view angle shift from a normal position to a superimposed position when the visibility support display is performed;

FIG. 49 is a diagram showing an example of display at the superimposed position when the visibility support display is performed; and

FIG. 50 is a diagram showing an example of a display during a period of view angle shift from a superimposed position to a normal position when the visibility support display is performed.

### DETAILED DESCRIPTION

In a configuration including a mechanism for shifting the position of the view angle where the virtual image is displayed, as in the conceivable technique, it takes time to mechanically shift the position of the view angle. Therefore, when performing a processing for displaying a specific content within the shifted view angle after completing the shift of the view angle, a time lag may occur until the start of display due to the shift of the view angle. When such a time lag is perceived by the occupant of the vehicle, even if the view angle capable of displaying the virtual image can be expanded, the occupant may tend to feel uncomfortable. As a result, the convenience of the virtual image display device may be impaired.

The present embodiments provide a virtual image display device and a display system capable of improving convenience.

In order to achieve the above object, one aspect is a virtual image display device that displays a virtual image visually recognizable by an occupant of a vehicle. The virtual image display device includes: a switching mechanism for switching the position of the view angle where the virtual image is displayed between a plurality of positions including a first position and a second position; and a display control unit that displays a virtual image associated with each of the first position and the second position in response to switching of the position of the view angle by the switching mechanism. When the specific content is displayed within the view angle of the second position after the switching mechanism shifts the view angle from the first position to the second position, the display control unit functions as a virtual image display device for stating the display of related content preliminarily associated with the specific content before the completion of the shift of the view angle to the second position.

In this aspect, the related content preliminarily associated with the specific content is displayed before the shift of the view angle from the first position to the second position is completed. Thus, the time lag to the start of the display due to the shift of the view angle by the switching mechanism is less likely to be perceived by a vehicle occupant. Therefore, even if a switching mechanism is provided to expand the view angle in which the virtual image can be displayed, the discomfort of the display can be reduced. As a result, it becomes possible to enhance the convenience of the virtual image display device.

The following will describe embodiments of the present disclosure with reference to the accompanying drawings. In the following description, the same reference symbols are assigned to corresponding components in each embodiment in order to avoid repetitive descriptions. In each of the embodiments, when only a part of the configuration is described, the remaining parts of the configuration may adopt corresponding parts of other embodiments. In addition to the combinations of configurations specifically shown in various embodiments, the configurations of various embodiments can be partly combined even if not explicitly suggested, unless such combinations are contradictory. It should be understood that such unspecified combinations of configurations described in various embodiments and variation examples are also disclosed by the following description.

### First Embodiment

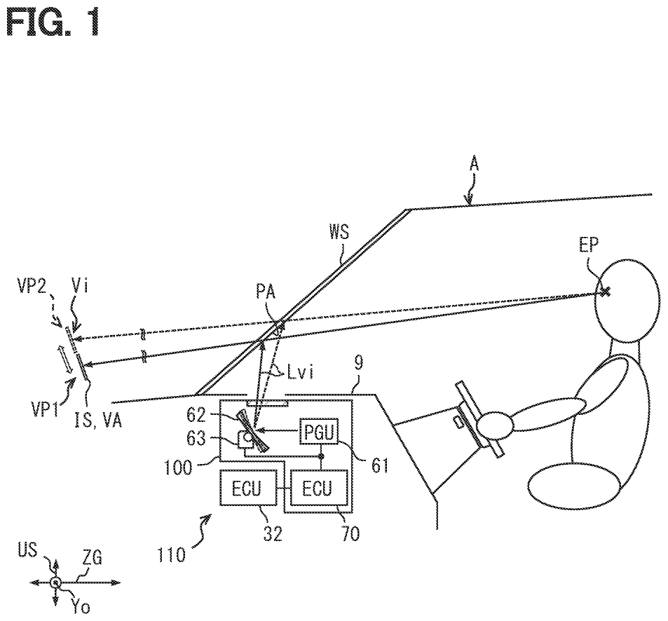

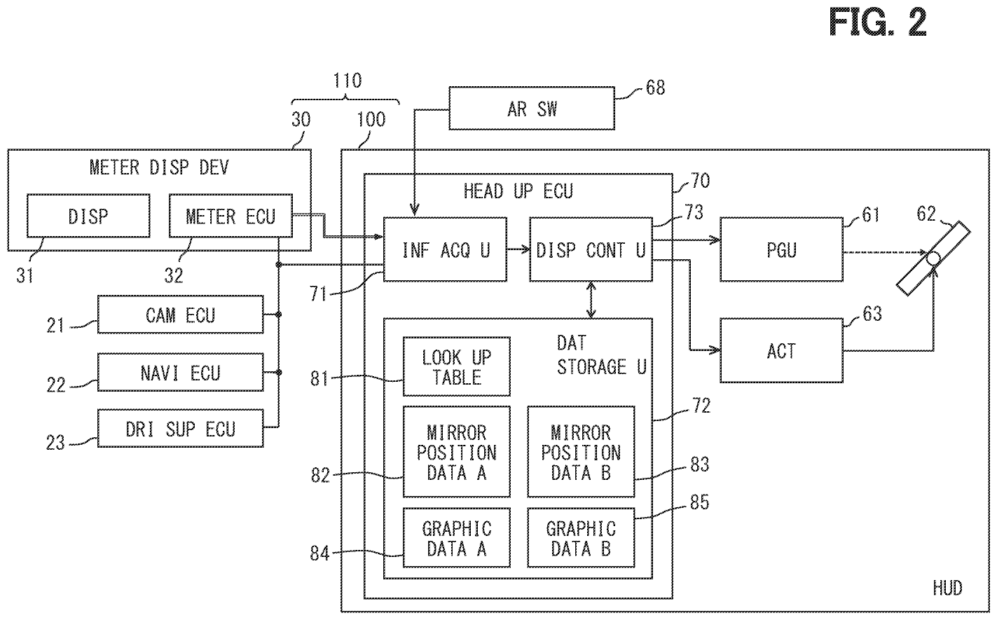

The functions of the virtual image display device according to the first embodiment of the present disclosure are implemented in a head-up display (hereinafter referred to as HUD) 100 shown in FIGS. 1 and 2. The HUD 100 constitutes a display system 110 together with the meter display device 30 and the like. The display system 110 is used in the vehicle A, and presents various information related to the vehicle A to the driver by linking virtual image display by the HUD 100 and screen display by the meter display device 30 and the like.

The HUD 100 and the meter display device 30 are connected to a communication bus of an in-vehicle network mounted on the vehicle A so as to be communicable. Other in-vehicle ECUs such as a camera ECU (Electronic Control Unit) 21, a navigation ECU 22, and a driving support ECU 23 are further connected to the communication bus of the in-vehicle network. Those structures connected as nodes to a communication bus can communicate with each other. Specific nodes of these ECUs and the like may be directly electrically connected to each other and communicate without the communication bus 99.

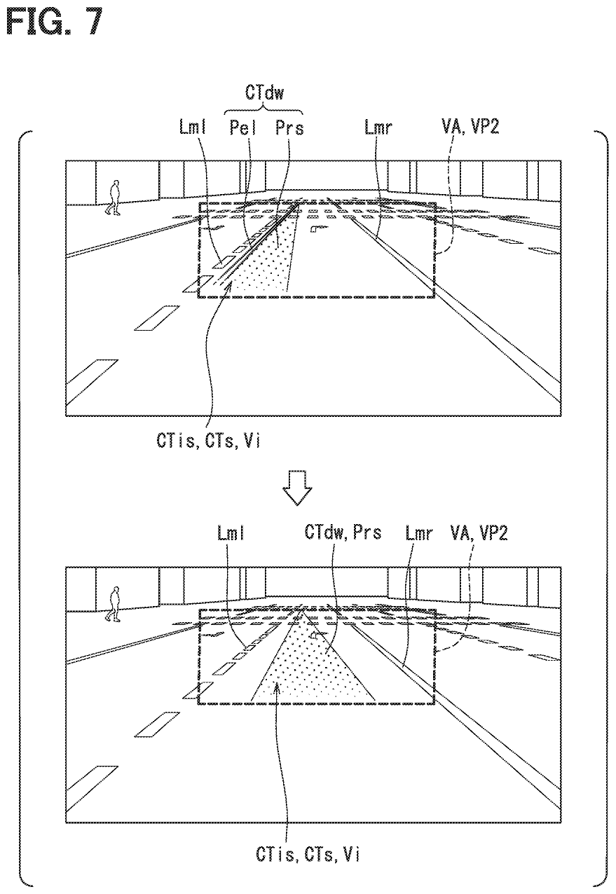

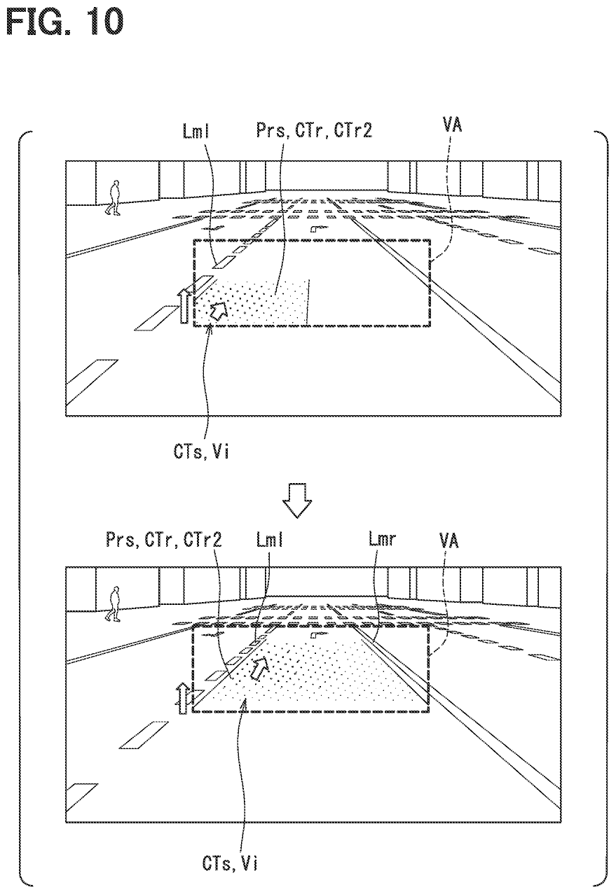

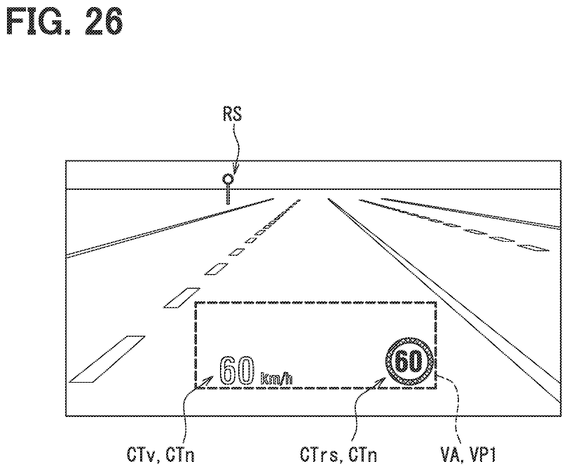

The camera ECU 21 is a processing device having a processor, RAM, storage, and the like, and is electrically connected to one or a plurality of in-vehicle cameras mounted on the vehicle A. The camera ECU 21 receives image data around the vehicle captured by an in-vehicle camera. The camera ECU 21 analyzes the image of an in-vehicle camera (hereinafter referred to as a front camera) that captures the image of the front of the vehicle A, and determines the distance to the preceding vehicle Af (see FIG. 10), the left and right lane markings Lml and Lmr of the vehicle (see FIG. 7), and the road sign RS (see FIG. 26) in front of the vehicle. The camera ECU 21 provides the driving support ECU 23 with detection information such as the preceding vehicle Af and the lane markings Lml and Lmr. The camera ECU 21 provides the HUD 100 and the meter display device 30 with the recognition information of the road sign RS recognized by the traffic sign recognition function.

The navigation ECU 22 is a processing device having a processor, RAM, storage, and the like, and performs route guidance to a destination set by the passenger. The navigation ECU 22 provides the HUD 100 and the meter display device 30 with route information about the guidance area when approaching a guidance area where the guidance to go straight, turn left or right, branch, merge, and the like is performed during the route guidance.

The driving support ECU 23 is a processing device having a processor, RAM, storage, and the like, and implements a plurality of support functions for supporting the driving of the driver of the vehicle A. As an example, the driving support ECU 23 has driving support functions such as LDW (Lane Departure Warning) and ACC (Adaptive Cruise Control).

The driving support ECU 23 uses the LDW function to determine whether the vehicle has deviated from the travelling lane over the lane markings Lml, Lmr based on the detection information of the lane markings Lml, Lmr acquired from the camera ECU 21. When the driving support ECU 23 determines that the vehicle has deviated from the travelling lane, the driving support ECU 23 provides lane departure information to the HUD 100 and the meter display device 30, and issues a lane departure warning to the driver.

The driving support ECU 23 uses the ACC function to cause the vehicle A to travel with a constant speed at the target vehicle speed, or based on the detection information of the preceding vehicle Af acquired from the camera ECU 21, while maintaining the inter-vehicle distance from the preceding vehicle Af, to cause the vehicle A to follow the preceding vehicle Af. The driving support ECU 23 provides status information indicating the control state of the ACC function to the HUD 100 and the meter display device 30 when the ACC function is operating.

Next, detailed configurations of the meter display device 30 and the HUD 100 will be described in order.

The meter display device 30 is one of a plurality of display devices mounted on the vehicle A, and presents information to the driver by displaying an image on the display screen. The meter display device 30 has a configuration corresponding to a combination meter, and is housed in the instrument panel 9 with the display screen facing the driver's seat. As an example, the meter display device 30 is installed in the vehicle interior of the vehicle A at a front position where the driver sitting in the driver's seat can easily visually recognize the meter display device 30. The meter display device 30 has a meter display 31 and a meter ECU 32.

The meter display 31 is, for example, a liquid crystal display or an organic EL display. The meter display 31 displays a speedometer image, a tachometer image, a navigation map image, a driving support image, and the like on the display screen based on video data acquired from the meter ECU 32.

The meter ECU 32 is an electronic control device that functions as an HCU (Human Machine Interface Control Unit) in the display system 110 and integrally controls the user interface functions of the vehicle A. The meter ECU 32 integrally controls display by display devices such as the meter display 31, the HUD 100, and the center display. The meter ECU 32 generates video data to be provided to the meter display 31 based on various information output to the communication bus.

The meter ECU 32 mainly includes a computer equipped with a processor, a RAM, a storage, an input/output interface, and a bus connecting these elements. The meter ECU 32 cooperates with a head-up ECU 70, which will be described later, to perform arithmetic processing for displaying a virtual image. The meter ECU 32 generates image data used for displaying a virtual image Vi, and sequentially outputs the generated image data to the HUD 100. The meter ECU 32 generates image data used for virtual image display such as lane departure warning, ACC status, turn-by-turn, and traffic sign recognition, which will be described later, and provides it to the HUD 100.

The HUD 100 is one of a plurality of display devices mounted on the vehicle A, and presents information to the driver using a virtual image Vi formed in a space in front of the driver. The HUD 100 is housed in a housing space provided inside the instrument panel 9. The HUD 100 projects light formed as a virtual image Vi (hereinafter referred to as virtual image light Lvi) toward the projection range PA of the windshield WS. The virtual image light Lvi projected toward the windshield WS is reflected within the projection area PA toward the driver's seat and is perceived by the driver. The driver visually recognizes a display in which a virtual image Vi is superimposed on a foreground scenery visible through the projection range PA.

The HUD 100 includes a PGU (Picture Generation Unit) 61 , a magnifying optical system 62 , an actuator 63 and a head-up ECU 70.

The PGU 61 includes an liquid crystal display (i.e., LCD) panel and a backlight. The PGU 61 is fixed to a housing of the HUD 100 so that the display surface of the LCD panel faces the magnifying optical system 62. The PGU 61 displays each frame image of the video data on the display surface of the LCD panel, and illuminates the display surface with the backlight that transmits the display surface. Thus, the virtual image light Lvi formed as a virtual image Vi is emitted toward the magnifying optical system 62.

The magnifying optical system 62 includes at least one concave mirror in which metal such as aluminum is vapor-deposited on a surface of base material made of, such as synthetic resin or glass. The magnifying optical system 62 projects the light emitted from the PGU 61 on an upper projection range PA while spreading the light by reflection.

The actuator 63 is a mechanism for mechanically shifting the region of the windshield WS that provides the projection range PA. A projection range PA is a range in which the virtual image light Lvi is projected, and is a range in which the virtual image Vi is visually displayed from the driver's perspective. The actuator 63 rotates the concave mirror of the magnifying optical system 62 around a rotation axis defined in the concave mirror, thereby changing the emission direction of the virtual image light Lvi from the magnifying optical system 62 toward the windshield WS. The actuator 63 shifts the projection range PA of the virtual image light Lvi, and thus the position of the view angle VA visually recognized by the driver, at least in the vertical direction US (see FIG. 1) by changing the posture of the concave mirror.

When a virtual range in the space where the virtual image Vi can be imaged is defined as an imaging plane IS, the view angle VA is defined as a viewing angle defined based on an virtual line connecting the driver's eye point EP and an outer edge of the image plane IS. The view angle VA is a range of angle within which the driver can visually recognize the virtual image Vi when viewed from the eye point EP. In the HUD 100, the horizontal view angle (for example, about 6 degrees) in the horizontal direction is larger than the vertical view angle (for example, about 2 degrees) in the vertical direction. As the view angle VA shifts in the vertical direction US, the front range within the view angle VA changes. As an example, when the actuator 63 positions the view angle VA at the lowest position (for example, the depression angle of about 3 degrees), the front range of ten-odd meters to twenty-odd meters is disposed within the view angle VA. On the other hand, when the actuator 63 positions the view angle VA to the highest position (for example, the depression angle of about 1 degree), the front range of about 30 m to 80 m is disposed within the view angle VA.

Here, the front-rear direction ZG and the left-right direction Yo are defined with reference to the vehicle A stationary on the horizontal plane. Specifically, the front-rear direction ZG is defined along a longitudinal direction (i.e., a traveling direction) of the vehicle A. The left-right direction Yo is defined along a width direction of the vehicle A. Furthermore, the up-down direction US is defined along the vertical direction of the horizontal plane defining the front-rear direction ZG and the left-right direction Yo. For simplification of description, the description of the reference numerals indicating each direction will be omitted as appropriate.

The head-up ECU 70 is a control circuit for the HUD 100 that integrally controls the PGU 61 and the actuator 63. The head-up ECU 70 mainly includes a computer equipped with a processor, a RAM, a storage, an input/output interface, and a bus connecting these elements. The head-up ECU 70 is further provided with a drive circuit for driving the LCD panel, the backlight and the actuator 63.

The head-up ECU 70 changes the content to be displayed as the virtual image Vi in association with the position of the view angle VA. Specifically, the head-up ECU 70 drives and controls the actuator 63 to switch the position of the view angle VA where the virtual image Vi is displayed between a plurality of positions including the normal position VP1 and the superimposed position VP2. The head-up ECU 70 displays the virtual image Vi associated with each of the normal position VP1 and the superimposed position VP2 in accordance with the switching of the position of the view angle VA by the actuator 63.

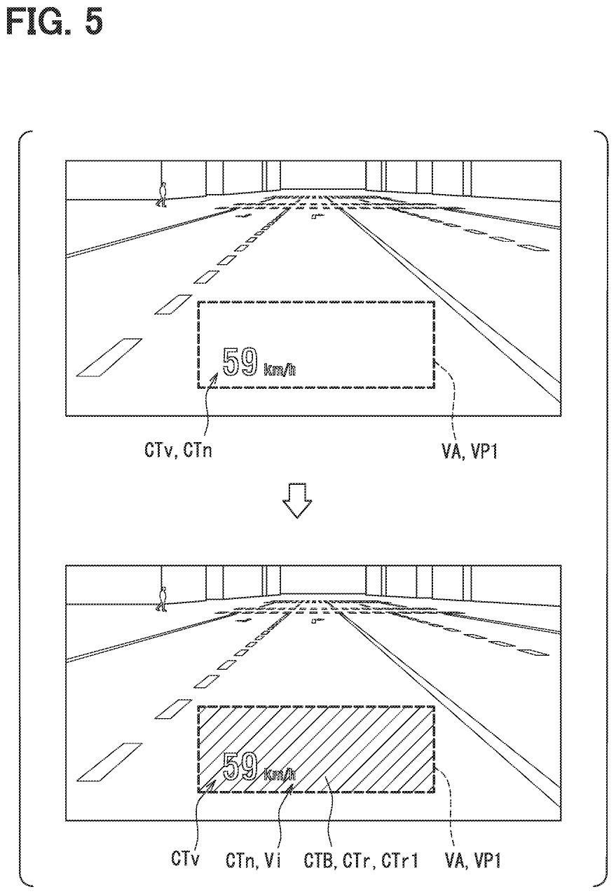

The normal position VP1 is a view angle position where the non-superimposed content CTn is mainly displayed as the virtual image Vi. The normal position VP1 is a standard position for the view angle VA, and corresponds to a constant position used for a longer period than the superimposed position VP2. The non-superimposed content CTn is a display object (i.e., a non-AR display object) excluding the superimposed content CTs, which will be described later, among display objects superimposed on the foreground. Different from the superimposed content CTs, the non-superimposed content CTn is displayed at a specific position within the projection range PA (i.e., within the view angle VA) without specifying the superimposition target. Therefore, the non-superimposed content CTn is visually recognize by the driver as if it is relatively fixed to the vehicle configuration such as the windshield WS. A state in which vehicle information such as vehicle speed is displayed by the non-superimposed content CTn at the normal position VP1 is a standard state for virtual image display by the HUD 100 (see the upper part of FIG. 5, and the like).

The superimposed position VP2 is a view angle position where the superimposed content CTs is mainly displayed as the virtual image Vi. The superimposed position VP2 is defined above the normal position VP1. The superimposed content CTs is AR display objects used for augmented reality (hereinafter referred to as “AR”) display. The display position of the superimposed content CTs is associated with a specific superimposed target existing in the foreground, such as a specific position on the road surface, a vehicle in front, a pedestrian, and a road sign. The superimposed content CTs is displayed in a superimposed manner on a specific superimposed target in the view angle VA, and is seemingly fixed relative to the specific superimposed target to be able to follow the specific superimposed target corresponding to a movement of driver's eye line. Therefore, the shape of the superimposed content CTs is continuously updated at a predetermined cycle according to the relative position and shape of the superimposed target. The superimposed content CTs is displayed in a posture closer to horizontal than the non-superimposition content CTn, and have, for example, a display shape extended in the depth direction as seen from the driver. As an example, when a specific event that should be notified to the driver occurs, the HUD 100 shifts the view angle VA from the normal position VP1 to the superimposed position VP2 and displays the superimposed content CTs.

As described above, the head-up ECU 70 executes the program (i.e., the virtual image display program) stored in the storage by the processing unit to realize the virtual image display control in which the view angle position and the content are linked, and provides the plurality of functional units. Specifically, the head-up ECU 70 includes functional units such as an information acquisition unit 71, a data storage unit 72, a display control unit 73, and the like.

The information acquisition unit 71 is connected to the communication bus and the meter ECU 32. The information acquisition unit 71 acquires recognition information of the road sign RS from the camera ECU 21, route information from the navigation ECU 22, lane departure information and status information from the driving support ECU 23, and the like through the communication bus. Image data for virtual image display generated by the meter ECU 32 is sequentially input to the information acquisition unit 71. The information acquisition unit 71 is electrically connected to the AR switch 68. The AR switch 68 is a switch for switching on and off the AR display using the superimposed content CTs. The information acquisition unit 71 detects the on and off states of the AR switch 68.

The data storage unit 72 provides a storage area that stores a plurality of data referred to by the display control unit 73. The data storage unit 72 may provide a storage area secured within the RAM, or may provide a partial storage area within the storage. A lookup table 81 , mirror position data 82 and 83 and graphic data 84 and 85 are prepared in the data storage unit 72 so that the display control unit 73 can refer to them.

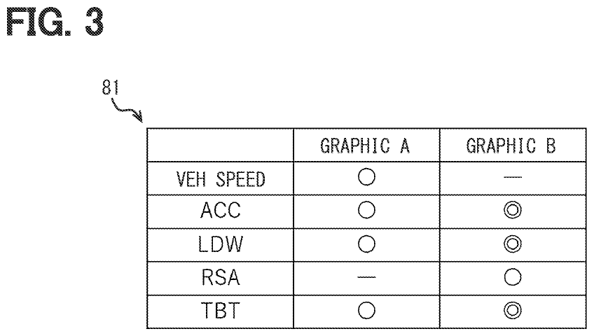

The lookup table 81 (see Lookup Table i FIG. 2) is information that links the view angle position and the content (see FIG. 3). The mirror position data 82 (see Mirror Position Data A in FIG. 2) is information that defines the angular position of the concave mirror when the view angle VA is set to the normal position VP1. The mirror position data 83 (see Mirror Position Data B in FIG. 2) is information that defines the angular position of the concave mirror when the view angle VA is set to the superimposed position VP2. Each of the mirror position data 82, 83 may be a value that is adjustable by the driver so as to match the position of the driver's eye point EP. The graphic data 84 (see Graphic Data A in FIG. 2) is image data (i.e., material data) used when the view angle VA is at the normal position VP1. The graphic data 85 (see Graphic Data B in FIG. 2) is image data (i.e., the material data) used when the view angle VA is at the superimposed position VP2.

The display control unit 73 is a control unit that integrally controls the PGU 61 and the actuator 63, and generates video data and control signals to be output to the PGU 61 and drive signals to be output to the actuator 63. The display control unit 73 switches between enabling and disabling the operation of shifting the view angle VA to the superimposed position VP2 based on the on and off state of the AR switch 68 detected by the information acquisition unit 71. When the AR switch 68 is in the off state, the display control unit 73 fixes the view angle VA to the normal position VP1 and suspends the display of the superimposed content CTs.

The display control unit 73 determines the position of the view angle VA based on the information acquired by the information acquisition unit 71 and the contents of the lookup table 81, and based on the determined view angle position, selects the content to be displayed as a virtual image. The display control unit 73 extracts material data of images used for generating video data from each of the graphic data 84 and 85 based on the content selection result. The display control unit 73 appropriately combines the image data generated from the graphic data 84 and 85 and the image data provided from the meter ECU 32 to generate each frame image of the video data. The display control unit 73 sequentially outputs video data including a large number of continuous frame images to the PGU 61.

When the position of the view angle VA is shifted, the display control unit 73 requires time (for example, about 1 second) to mechanically rotate the concave mirror by the actuator 63. Therefore, after completing the shift of the view angle VA from one of the normal position VP1 and the superimposed position VP2 to the other, when the virtual image Vi (i.e., the specific content CTis) is displayed within the view angle VA after the shift, a time lag due to the shift of the view angle VAA time lag occurs until the display starts. The display control unit 73 starts displaying the related content CTr preliminarily associated with the specific content CTis before the shift of the view angle VA is completed so that such a time lag does not cause the driver to feel uncomfortable.

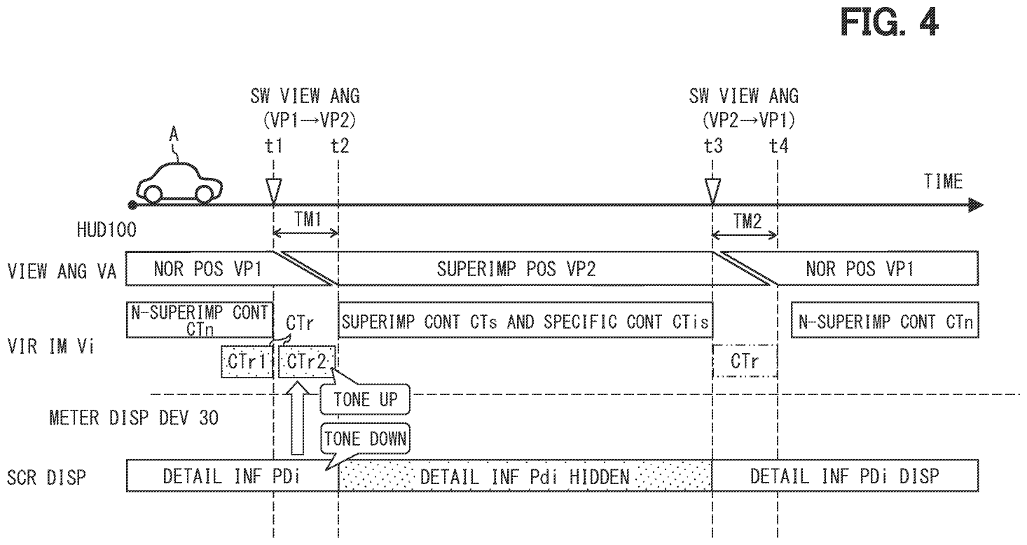

Specifically, as shown in FIGS. 4 and 2, the display control unit 73 displays the related content CTr when shifting the view angle VA from the normal position VP1 to the superimposed position VP2. The related content CTr is displayed in a manner related to the specific content CTis to be displayed within the view angle VA of the superimposed position VP2 after the actuator 63 shifts the view angle VA from the normal position VP1 to the superimposed position VP2. Being related means, for example, that the related content CTr draws attention to the specific content CTis, that the related content CTr is assimilated with the specific content CTis, that part of the specific content CTis is displayed as the related content CTr, and the like. As another example, the specific content CTis and the related content CTr may be associated on display by using display colors that are similar or identical to the extent that the driver recognizes them as being the same. Furthermore, even if the related content CTr includes the same information as the specific content CTis, the related content CTr may be related to the specific content CTis.

The related content CTr includes a first related content CTr1 and a second related content CTr2. The first related content CTr1 starts to be displayed before the time t1 at which the actuator 63 starts shifting the view angle VA from the normal position VP1. The display of the first related content CTr1 ends at time t1. The first related content CTr1 is displayed, for example, as the background of the non-superimposed content CTn to be displayed at the normal position VP1, and blinks multiple times until the display ends at time t1.

The second related content CTr2 is displayed in a shifting period (hereinafter referred to as a shift period TM1) in which the view angle VA is being shifted by the actuator 63. The display of the second related content CTr2 starts after the time t1 when the display of the first related content CTr1 ends, and ends before the time t2 when the shift of the view angle VA is completed. The second related content CTr2 is content in a different manner from the first related content CTr1. For example, the first related content CTr1 is the non-superimposed content CTn, while the second related content CTr2 is either the superimposed content CTs or the non-superimposed content CTn. The display control unit 73 causes a tone-up display change in which the luminance of the second related content CTr2 is increased continuously or stepwise as the view angle position approaches the superimposed position VP2. As a result, the second related content CTr2 becomes a more attractive display object as the shift of the view angle VA proceeds.

On the other hand, when shifting the view angle VA from the superimposed position VP2 to the normal position VP1, the display control unit 73 does not display the related content CTr. The display control unit 73 ends the superimposed display of the specific content CTis before time t3 when the actuator 63 starts shifting the view angle VA from the superimposed position VP2 to the normal position VP1. The display control unit 73 temporarily suspends all virtual image display during a period in which the view angle VA is shifted by the actuator 63 (hereinafter referred to as a shift period TM2). The display control unit 73 restarts the display of the non-superimposed content CTn at time t4 when the view angle position reaches the normal position VP1 or at a timing after a predetermined time (for example, about one second) has passed from time t4. Here, when displaying a part of the specific content CTis, the related content CTr to be displayed during the shift period TM1 may also be displayed during the shift period TM2.

The meter ECU 32 changes the display of the display screen of the meter display 31 in cooperation with the switching of the position of the view angle VA by the actuator 63 in the HUD 100. The meter ECU 32 causes the display screen to display detailed information PDi related to the specific content CTis. The detailed information PDi is the same type of information as the specific content CTis, and presents the driver with more detailed content than the specific content CTis.

When the view angle VA shifts from the normal position VP1 to the superimposed position VP2, the meter ECU 32 causes the display change of the tone down operation for reducing continuously or stepwise the image brightness of the detailed information PDi displayed on the screen during the shift period TM1 from time t1 to time t2. Accordingly, as the view angle VA shifts, the detailed information PDi becomes a less attractive display object. As a result, the display change is performed so that the brightness is transferred from the screen display of the meter display device 30 to the virtual image display by the HUD 100, and the driver's line of sight is guided to the foreground.

The meter ECU 32 hides the detailed information PDi at time t2 when the shift of the view angle VA to the superimposed position VP2 is completed. The meter ECU 32 continues the hidden state of the detailed information PDi during the period in which the view angle VA is disposed at the superimposed position VP2 and the display of the specific content CTis continues. As a result, the situation in which the detailed information PDi attracts the driver's attention and obstructs the driver's visual recognition of the outside the vehicle does not occur. The screen display of images other than the detailed information PDi continues during the period from time t2 to time t3.

On the other hand, when the view angle VA shifts from the superimposed position VP2 to the normal position VP1, the meter ECU 32 restarts the screen display of the detailed information PDi at the timing when the display of the specific content CTis ends. As an example, at time t3 when the shift of the view angle VA is started, the display of the detailed information PDi is restarted. As described above, even after the specific content CTis is hidden, the state in which the information provided by the specific content CTis can be confirmed is maintained.

Next, a plurality of scenes in which the specific content CTis is displayed by shifting the view angle VA from the normal position VP1 to the superimposed position VP2 will be described below based on FIGS. 5 to 31 and with reference to FIGS. 1 to 4.

<Lane Departure Warning>

FIGS. 5 to 10 illustrate multiple patterns of lane departure warnings implemented by the display system 110. FIGS. 5 to 7 show the lane departure warning with the pattern 1, FIGS. 5, 6 and 7 show the lane departure warning with the pattern 2, and FIGS. 5, 9 and 10 indicates lane departure warning with the pattern 3.

The display control unit 73 displays the speedometer CTv at the view angle VA at the normal position VP1 before the lane departure warnings of patterns 1 to 3 are started (see the upper part of FIG. 5). The speedometer CTv is non-superimposed content CTn that digitally displays the vehicle speed. The display control unit 73 determines execution of the lane departure warning by using the acquisition of the lane departure information by the information acquisition unit 71 as a trigger. The display control unit 73 displays the blinking background CTB while continuing to display the speedometer CTv (see the lower part of FIG. 5).

The blinking background CTB is the non-superimposed content CTn displayed as the first related content CTr1. The blinking background CTB is a horizontally long rectangular image that fills the entire view angle VA. The blinking background CTB is displayed so as to be the background of the speedometer CTv so as not to obstruct the visibility of the speedometer CTv. The blinking background CTB is a virtual image Vi in a warning color such as red. After blinking a plurality of times, the display of the blinking background CTB ends together with the speedometer CTv at time t1.

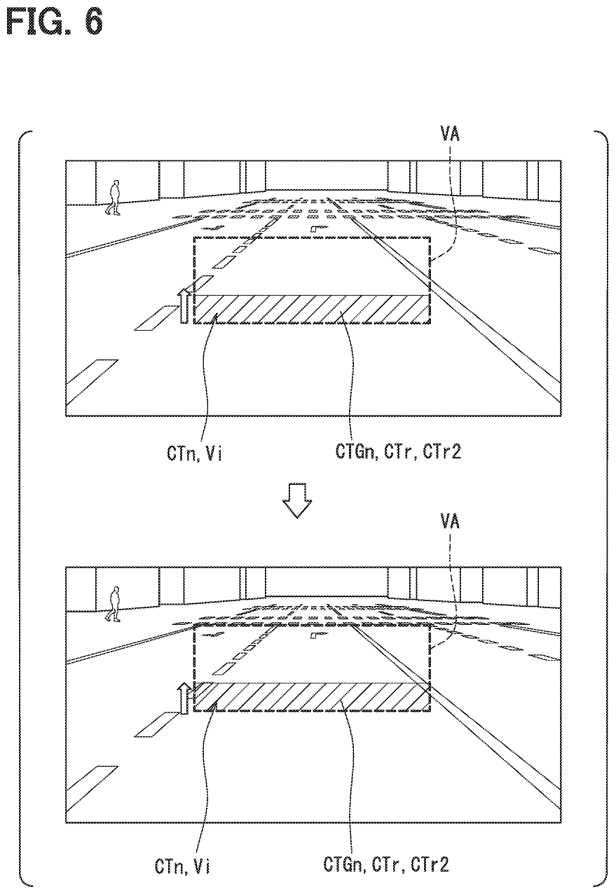

In the lane departure warning of pattern 1, when the view angle VA starts to shift at time t1, the display control unit 73 starts displaying the guidance content CTGn (see the upper part of FIG. 6). The guidance content CTGn is the non-superimposed content CTn displayed as the second related content CTr2. The guidance content CTGn is related content CTr in a different manner from the blinking background CTB, and is a non-blinking image displayed so as to fill in part of the view angle VA. The guidance content CTGn has a horizontally elongated rectangular shape in contact with the lower edge of the view angle VA, and is a virtual image Vi in a warning color such as red, similar to the blinking background CTB. The width of the guidance content CTGn in the up-down direction is about half to one-third of the vertical view angle at the start of display. The display control unit 73 reduces the guidance content CTGn in the up-down direction in accordance with the upward shift of the view angle VA, and shifts the whole of the guidance content CTGn upward from the driver's perspective (see the lower part of FIG. 6). The display control unit 73 ends the display of the guidance content CTGn before time t2 when the view angle VA reaches the superimposed position VP2.

After completing the shift of the view angle VA to the superimposed position VP2 at time t2, the display control unit 73 starts displaying the departure warning content CTdw (see the upper part of FIG. 7). The departure warning content CTdw is the specific content CTis in the lane departure warning. The departure warning content CTdw is also the superimposed content CTs which is superimposed on the road surface of the vehicle's lane in the foreground as a superimposed target, and warns the vehicle A of departure from the vehicle's lane during travel. The departure warning content CTdw includes a road surface superimposed image Prs and a boundary-enhanced image Pel.

The road surface superimposed image Prs is displayed as a virtual image in a warning color such as red, and superimposed so as to paint out a part of the road surface ahead of the own vehicle lane. When the vehicle A is about to deviate from the left lane marking Lml, the road superimposed image Prs is superimposed in the vicinity of the left lane marking Lml of the own vehicle. The road surface superimposed image Prs is displayed as an animation that repeatedly shifts from the lane marking Lml on the left side of the vehicle to the lane marking Lmr on the right side of the vehicle (see the lower part of FIG. 7), and prompts the driver to move to the center of the travelling lane.

The boundary-enhanced image Pel is an image with a different display color (for example, white) from the road surface superimposed image Prs. When the vehicle A is about to deviate to the left side of the own vehicle lane, the boundary-enhanced image Pel has a shape extending in a thin strip along the lane marking Lml on the left side of the own vehicle, and is arranged between the road surface superimposed image Prs and the lane marking Lml. The boundary-enhanced image Pel repeats the display state and the hidden state in accordance with the animation of the road surface superimposed image Prs, and becomes the hidden image at the timing when the road surface superimposed image Prs separates from the lane marking Lml (see the lower part of FIG. 7). When the vehicle A is about to deviate to the right side of the vehicle's lane, the road superimposed image Prs and the boundary-enhanced image Pel are displayed along the lane marking Lmr on the right side of the vehicle.

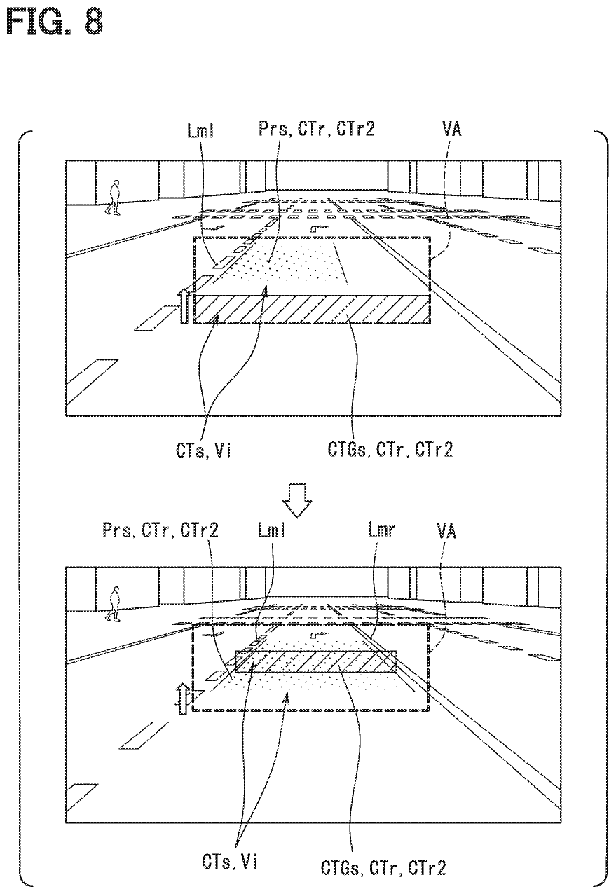

In the lane departure warning of pattern 2, when the view angle VA starts to shift at time t1, the display control unit 73 starts displaying the road surface superimposed image Prs and the guidance content CTGs (see the upper part of FIG. 8). The road surface superimposed image Prs and the guidance content CTGs are the superimposed content CTs displayed as the second related content CTr2.

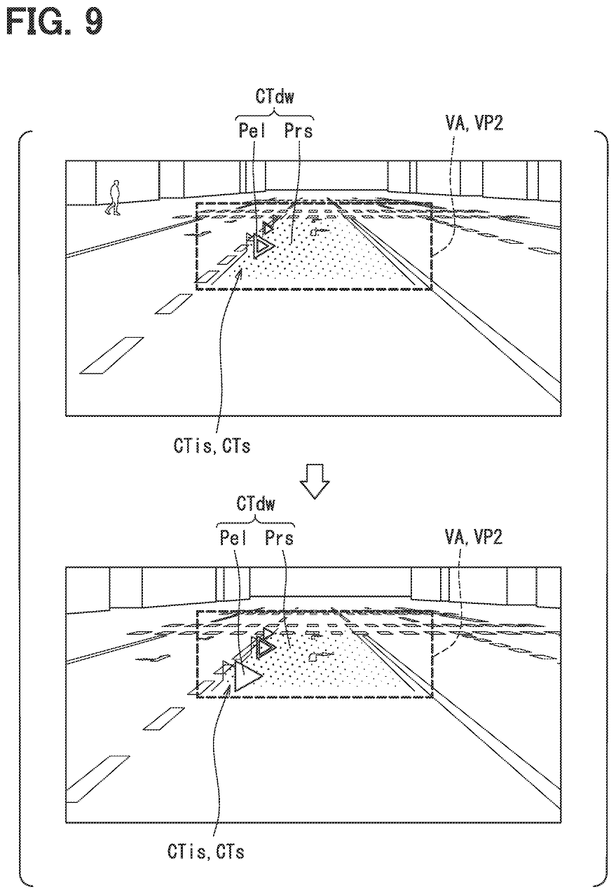

The road surface superimposed image Prs is a part of the departure warning content CTdw (see FIG. 9), and is superimposed and displayed at a position facing the lane marking Lml on the departure side so as to partially fill in the road surface ahead of the own vehicle lane. The road surface superimposed image Prs may be the superimposed content CTs that approaches the vehicle together with the road surface ahead, or may be the superimposed content CTs that is superimposed on the road surface in front of the vehicle at a predetermined distance from the vehicle.

The guidance content CTGs is the related content CTr in a different manner from the blinking background CTB (see FIG. 5), and is displayed so as to fill in part of the view angle VA. The guidance content CTGs is a virtual image Vi with red or other colors having a horizontally long rectangular shape in contact with the lower edge of the view angle VA, similar to the guidance content CTGn of pattern 1 (see FIG. 6). The guidance content CTGs is arranged on the front side of the road surface superimposed image Prs as seen from the driver. The display control unit 73 shifts the guidance content CTGs toward the vanishing point in the foreground while the view angle VA is shifting upward. Specifically, as the view angle VA shifts upward, the guidance content CTGs is reduced in the up-down direction and the right-left direction while maintaining the aspect ratio, and shifts upward so as to be disposed between the lane markings Lml and Lmr (see lower part of FIG. 8). Due to such a mode change, the guidance content CTGs is visually recognized as if it shifts to the far side of the own vehicle lane, and guides the driver's line of sight far away.

After completing the shift of the view angle VA to the superimposed position VP2 at time t2, the display control unit 73 starts displaying the departure warning content CTdw (see the upper part of FIG. 9). The departure warning content CTdw of pattern 2 is the superimposed content CTs including a road surface superimposed image Prs and a boundary-enhanced image Pel. The road surface superimposed image Prs starts to be displayed while the view angle VA is shifting as described above, and continues to be displayed even after the shift of the view angle VA is completed. The road surface superimposed image Prs is superimposed on the front road surface at a predetermined distance from the vehicle.

The boundary-enhanced image Pel is drawn, for example, in white, and displayed and superimposed on the road surface superimposed image Prs. The boundary-enhanced image Pel is drawn in a triangular shape pointing toward the center so as to prompt the driver to move toward the center of the vehicle's lane. The display control unit 73 displays a plurality of boundary-enhanced images Pel at predetermined intervals along the lane marking Lml on the departure side. The plurality of boundary-enhanced images Pel shift on the road surface superimposed image Prs along the lane marking Lml while being enlarged in accordance with the travelling of the vehicle, and are visually recognized by the driver as approaching the vehicle together with the road surface in front (See the lower part of FIG. 9).

In the lane departure warning of pattern 3, display of guidance content CTGs (see FIG. 8) of pattern 2 is omitted. The display control unit 73 displays the road surface superimposed image Prs as the second related content CTr2 (see the upper part of FIG. 10). The road superimposed image Prs is superimposed and displayed so as to face the lane marking Lml on the departure side, and is enlarged toward the vanishing point in the foreground within a range that does not protrude from the own vehicle lane in accordance with the upward shift of the view angle VA (see the upper part of FIG. 10). Even after the shift of the view angle VA is completed, the road surface superimposed image Prs is continuously displayed within the view angle VA of the superimposed position VP2 as a part of the departure warning content CTdw (see FIG. 9).

<Notification of ACC Status Change>

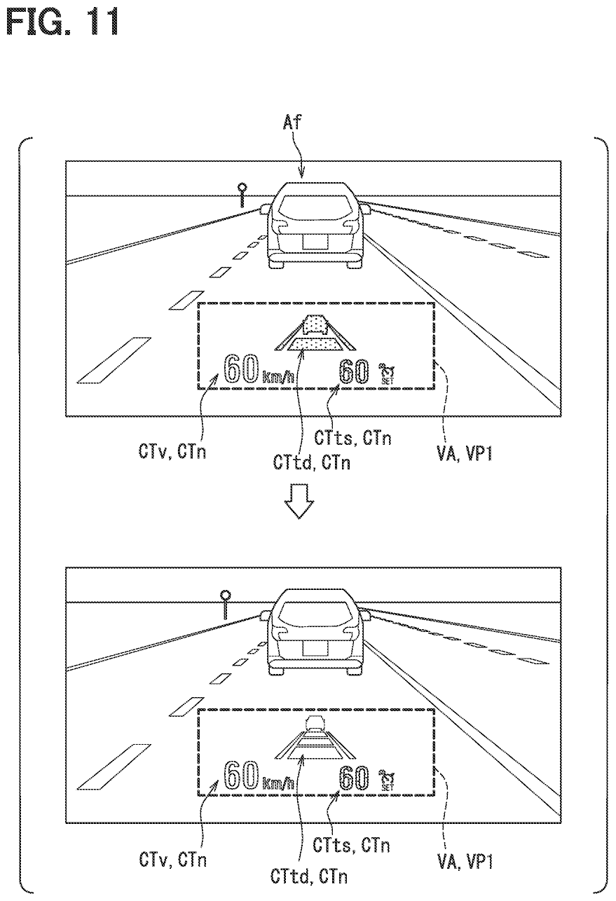

FIGS. 11 to 19 illustrate multiple patterns of ACC status change notifications implemented by the display system 110. FIGS. 11 to 13 show the ACC status change notifications with the pattern 1, and FIGS. 11, 14 and 15 show the ACC status change notifications with the pattern 2. FIGS. 11, 16 and 17 show the ACC status change notifications with the pattern 3, and FIGS. 11, 18 and 19 show the ACC status change notifications with the pattern 4.

When the ACC function is activated by the driving support ECU 23, the target vehicle speed CTts and the target inter-vehicle distance CTtd are displayed in addition to the speedometer CTv at the view angle VA at the normal position VP1 (see upper part of FIG. 11). The target vehicle speed CTts and the target inter-vehicle distance CTtd are non-superimposed contents CTn indicating control target values set for the ACC function. The target vehicle speed CTts indicates the upper limit vehicle speed when the ACC function causes the vehicle A to cruise at a constant speed. The target inter-vehicle distance CTtd indicates the length of the inter-vehicle distance (hereinafter referred to as the target inter-vehicle distance) when the ACC function causes the vehicle A to follow the preceding vehicle Af.

The ACC status change notification is made when the target inter-vehicle distance set in the ACC function is changed (e.g., lengthened) by the driver (see the lower part of FIG. 11). The display before the ACC status change notification is started is common to patterns 1-4. Triggered by the acquisition of status information indicating a change in the target inter-vehicle distance, the display control unit 73 determines to notify the change of the ACC status, and hides the speedometer CTv and the target vehicle speed CTts.

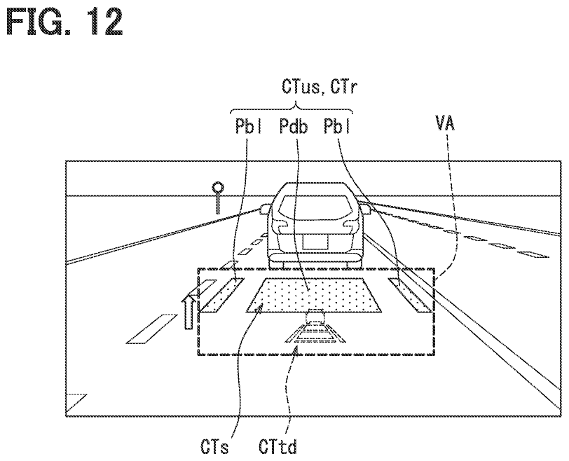

In pattern 1 of the ACC status change notification, when the view angle VA starts to shift at time t1, the display control unit 73 gradually reduces the display brightness of the target distance CTtd. Due to such a tone-down display change, the target inter-vehicle distance CTtd is hidden during the shift period TM1. In addition, the display control unit 73 starts displaying the partial display content CTus (see FIG. 12).

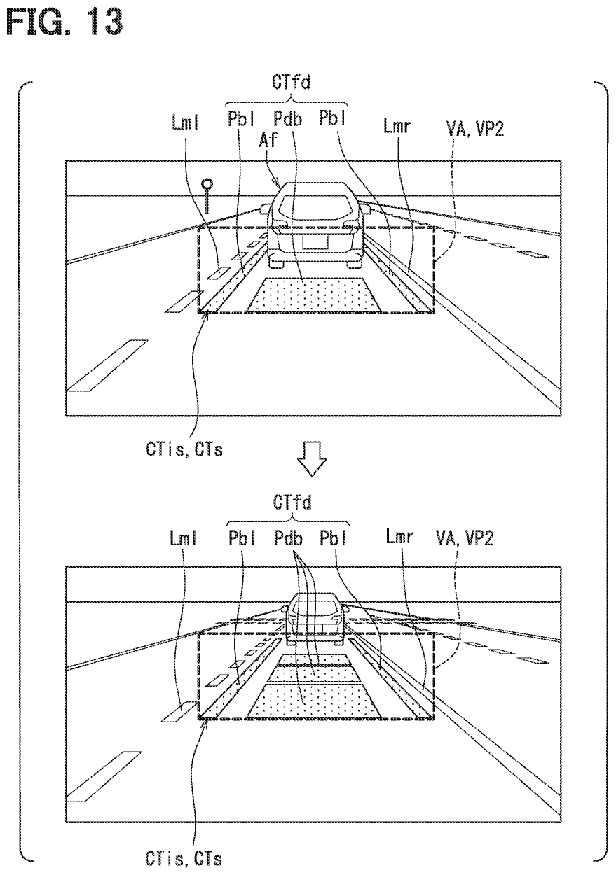

The partial display content CTus is displayed as the related content CTr. The partial display content CTus is a part of the specific content CTis (see FIG. 13) displayed after the shift of the view angle VA is completed. When the view angle VA shifts upward, the lower portion of the specific content CTis is displayed as the partial display content CTus. The partial display content CTus is the superimposed content CTs including a block image Pdb and a set of lane marking images Pbl, and superimposed and displayed on the front road surface.

After completing the shift of the view angle VA to the superimposed position VP2 at time t2, the display control unit 73 starts displaying the inter-vehicle distance notification content CTfd (see the upper part of FIG. 13). The inter-vehicle notification content CTfd is the specific content CTis in the ACC status change notification. The inter-vehicle distance notification content CTfd is the superimposed content CTs that is superimposed on the road surface of the own vehicle lane in the foreground, and notifies the driver of the change in the operating state of the adaptive cruise control using the ACC function, specifically, the implementation of deceleration control to increase the inter-vehicle distance from the preceding vehicle Af. The inter-vehicle distance notification content CTfd includes a block image Pdb and a set of lane marking images Pbl.

The block image Pdb is a virtual image displayed in blue, green, or the like, and is a trapezoidal image superimposed on the center of the road surface ahead of the own vehicle lane. The block image Pdb is displayed below the vehicle Af in front so as not to overlap the vehicle Af in front from the driver's point of view. When the inter-vehicle distance to the vehicle Af in front increases due to deceleration control by the ACC function, the display control unit 73 increases the number of block images Pdb displayed below the vehicle Af in front (see the upper part of FIG. 13).

The lane marking image Pbl is displayed as a virtual image in substantially the same blue or green color as the block image Pdb, and is superimposed on both sides of the block image Pdb one by one. Each lane marking image Pbl is a strip-shaped image that extends from the subject vehicle side toward the vanishing point along the adjacent lane markings Lml and Lmr. The lane marking image Pbl is allowed to overlap the preceding vehicle Af as seen by the driver, and extends obliquely from the lower edge to the upper edge of the view angle VA at the superimposed position VP2.

When the change of the target inter-vehicle distance by the ACC function is completed, the display control unit 73 ends the ACC status change notification and returns the view angle VA to the normal position VP1. The inter-vehicle distance notification content CTfd may be hidden before time t3 when the shift of the view angle VA is started, or may be gradually hidden from the upper side to the lower side in accordance with the shift of the view angle VA. After completing the shift of the view angle VA to the normal position VP1 at time t4, the display control unit 73 restarts the display of the speedometer CTv, the target vehicle speed CTts, and the target inter-vehicle distance CTtd (see the upper part of FIG. 11).

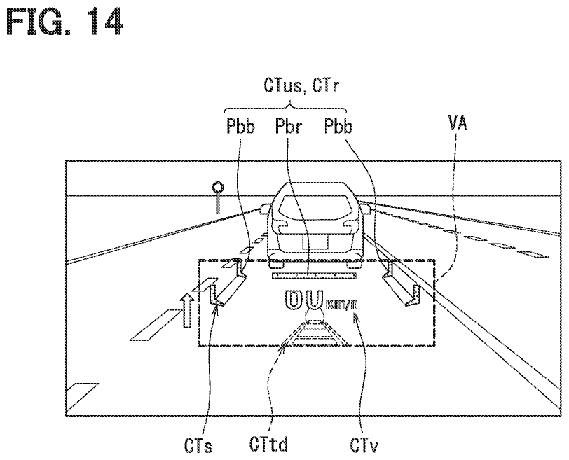

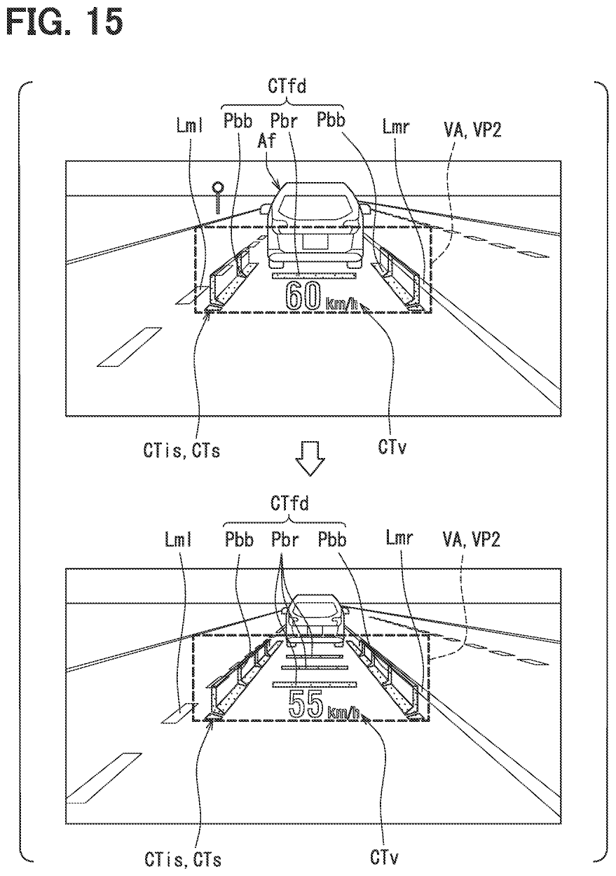

Even in the ACC status change notification of pattern 2, when the shift of the view angle VA is started at time t1, the display control unit 73 hides the target inter-vehicle distance CTtd by toning down and start displaying the partial display content CTus (see FIG. 14). The partial display content CTus is a part of the specific content CTis (see FIG. 15) displayed after the shift of the view angle VA is completed, and includes a bar image Pbr and a set of partition wall images Pbb. The display control unit 73 further displays the speedometer CTv together with the partial display content CTus. The bar image Pbr, the partition wall image Pbb, and the speedometer CTv are gradually displayed from the bottom to the top as the view angle VA shifts.

After completing the shift of the view angle VA to the superimposed position VP2 at time t2, the display control unit 73 starts displaying the inter-vehicle distance notification content CTfd (see the upper part of FIG. 15). The inter-vehicle notification content CTfd includes the above-described bar image Pbr and a set of partition wall images Pbb. The bar image Pbr is an image corresponding to the block image Pdb of pattern 1 (see FIG. 13), and has a bar-like shape extending in the horizontal direction. The bar image Pbr is displayed between the preceding vehicle Af and the speedometer CTv in the driver's view. When the inter-vehicle distance to the preceding vehicle Af is increased by the deceleration control of the ACC function, the number of bar images Pbr displayed below the preceding vehicle Af increases (see the lower part of FIG. 15).

The partition wall image Pbb is an image corresponding to the lane marking image Pbl (see FIG. 13) of Pattern 1, and is superimposed on both sides of the bar image Pbr and the speedometer CTv. Each partition wall image Pbb includes a plurality of wall-shaped image portions standing upward from the road surface, and are arranged in a wall shape along the adjacent lane markings Lml and Lmr. In each partition wall image Pbb, the number of wall-shaped image portions increases when the inter-vehicle distance to the preceding vehicle Af increases due to deceleration control by the ACC function (see the lower part of FIG. 15).

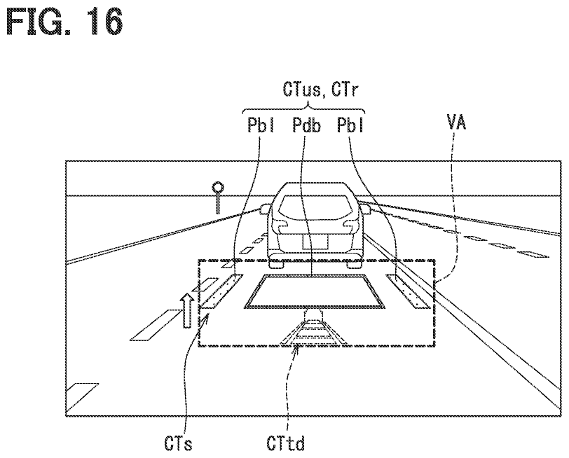

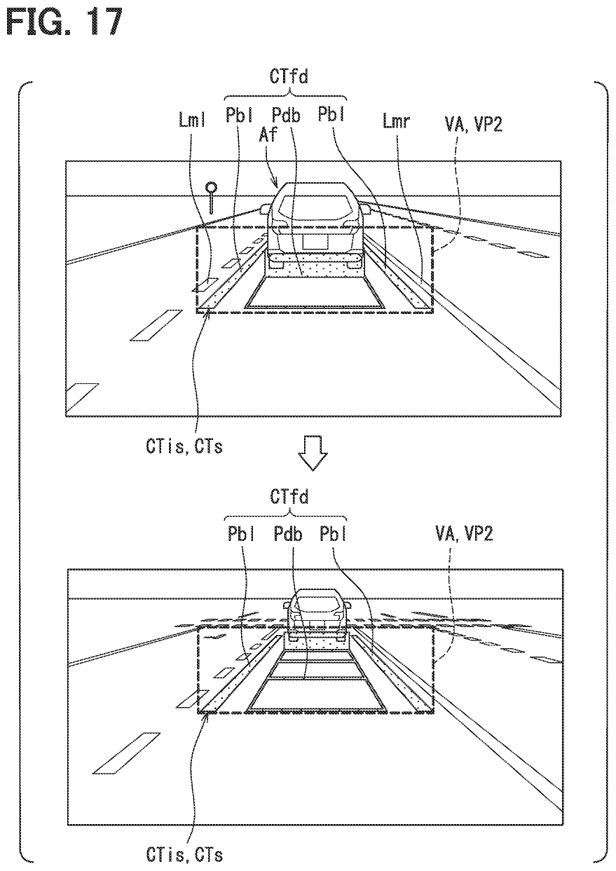

Even in the ACC status change notification of pattern 3, when the shift of the view angle VA is started at time t1, the display control unit 73 tones down the target inter-vehicle distance CTtd and start displaying the partial display content CTus (see FIG. 16). The partial display content CTus is a part of the specific content CTis (see FIG. 17) displayed after the shift of the view angle VA is completed, and is the related content CTr of the specific content CTis. The partial display content CTus includes a block image Pdb and a set of lane marking images Pbl superimposed on the road ahead. The block image Pdb and the lane marking image Pbl are gradually displayed from the bottom to the top as the view angle VA shifts upward.

After completing the shift of the view angle VA to the superimposed position VP2 at time t2, the display control unit 73 draws the entire of the block image Pdb and each lane marking image Pbl, thereby starting the display of the inter-vehicle distance notification content CTfd as the specific content CTis (see the upper part of FIG. 17). The block image Pdb is drawn in a trapezoidal frame shape and includes an emphasis portion that emphasizes the preceding vehicle Af from below. When the inter-vehicle distance to the preceding vehicle Af is increased by the deceleration control of the ACC function, a plurality of block images Pdb are continuously drawn below the emphasis portion (see the lower part of FIG. 17). The lane marking image Pbl is a strip-like image that is substantially the same as the lane marking image Pbl of pattern 1 (see FIG. 13). Each lane marking image Pbl is arranged along the lane markings Lml and Lmr on both left and right sides of the block image Pdb.

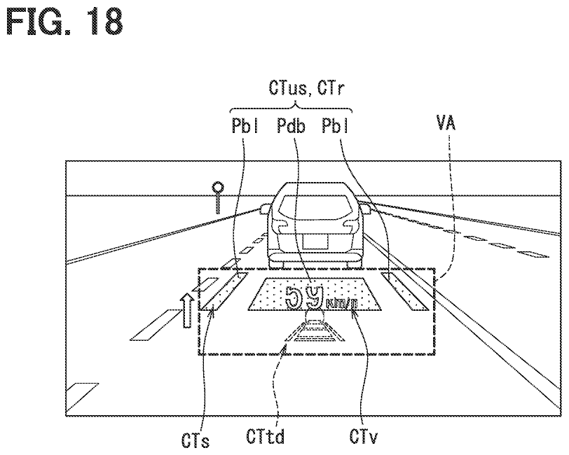

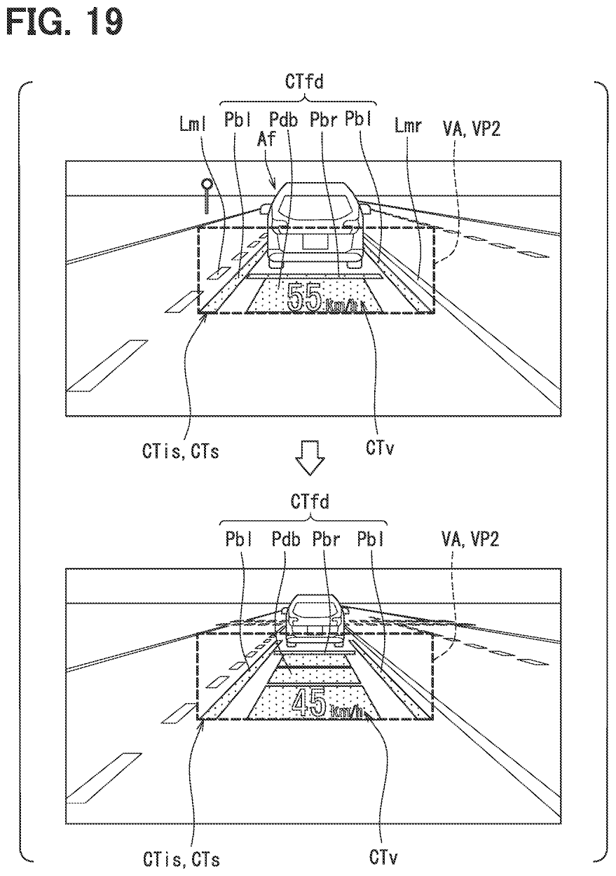

Even in the ACC status change notification of pattern 4, when the shift of the view angle VA is started at time t1, the display control unit 73 tones down the target inter-vehicle distance CTtd and start displaying the partial display content CTus and the speedometer CTv (see FIG. 18). The partial display content CTus is a part of the specific content CTis (see FIG. 19) and is the related content CTr of the specific content CTis. The partial display content CTus is the superimposed content CTs including the block image Pdb and the lane marking image Pbl. The block image Pdb, each lane marking image Pbl, and the speedometer CTv are gradually displayed from the bottom to the top as the view angle VA shifts upward.

After completing the shift of the view angle VA to the superimposed position VP2 at time t2, the display control unit 73 starts displaying the inter-vehicle distance notification content CTfd as the specific content CTis (see the upper part in FIG. 19). The inter-vehicle distance notification content CTfd is displayed behind the speedometer CTv. The inter-vehicle distance notification content CTfd includes a bar image Pbr in addition to the block image Pdb and the lane marking image Pbl which started to be displayed during the shift of the view angle VA. The block image Pdb and the lane marking image Pbl are substantially the same images as the pattern 1 (see FIG. 13). The bar image Pbr is superimposed on the road surface below the preceding vehicle Af to emphasize the preceding vehicle Af from below. When the inter-vehicle distance to the preceding vehicle Af increases due to deceleration control of the ACC function, the display control unit 73 shifts the bar image Pbr upward and additionally displays a plurality of block images Pdb below the bar image Pbr (see the bottom of FIG. 19).

<Turn-by-Turn Display>

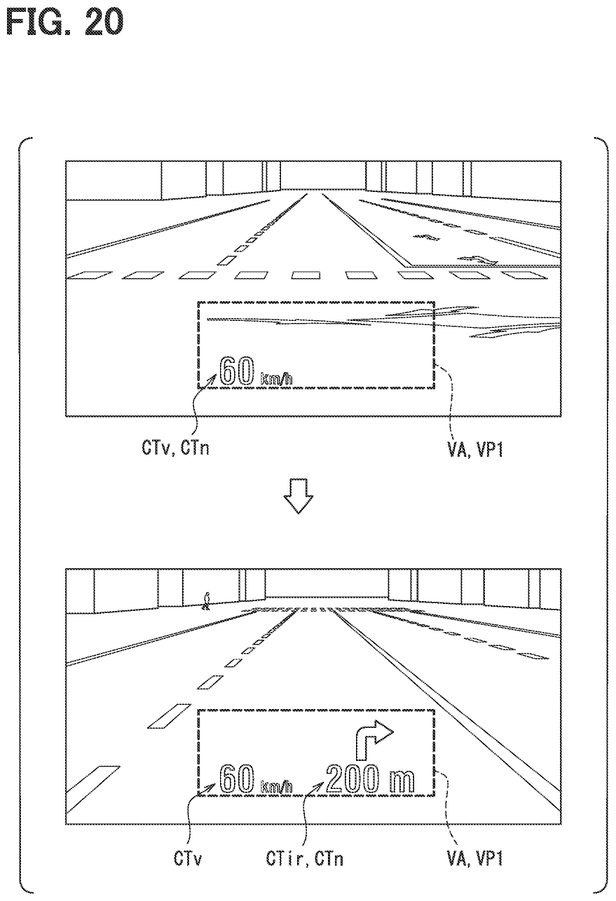

FIGS. 20 to 25 illustrate multiple patterns of route guidance implemented by the display system 110. FIGS. 20 to 22 show turn-by-turn displays in the route guidance of pattern 1, and FIGS. 20, 21 and 23 show turn-by-turn displays in the route guidance of pattern 2. FIGS. 20, 21 and 24 show the turn-by-turn display of pattern 3, and FIGS. 20, 21 and 25 show the turn-by-turn displays of pattern 4.

When the navigation ECU 22 is providing route guidance to the destination, a route icon CTir is displayed in addition to the speedometer CTv at the view angle VA at the normal position VP1 as the guidance point approaches (see the lower part in FIG. 20). A guidance point is set based on a specific node in a guidance area such as an intersection, a merging section, and a branching section.

The route icon CTir is a non-superimposed content CTn indicating the remaining distance to the guide point and the direction of right or left turn at the guide point. The display control unit 73 determines execution of turn-by-turn display, triggered by the fact that the information acquisition unit 71 acquires the route information about the nearest guidance area. After displaying the root icon CTir, the display control unit 73 hides all the contents including the speedometer CTv and the root icon CTir, and starts shifting the view angle VA to the superimposed position VP2.

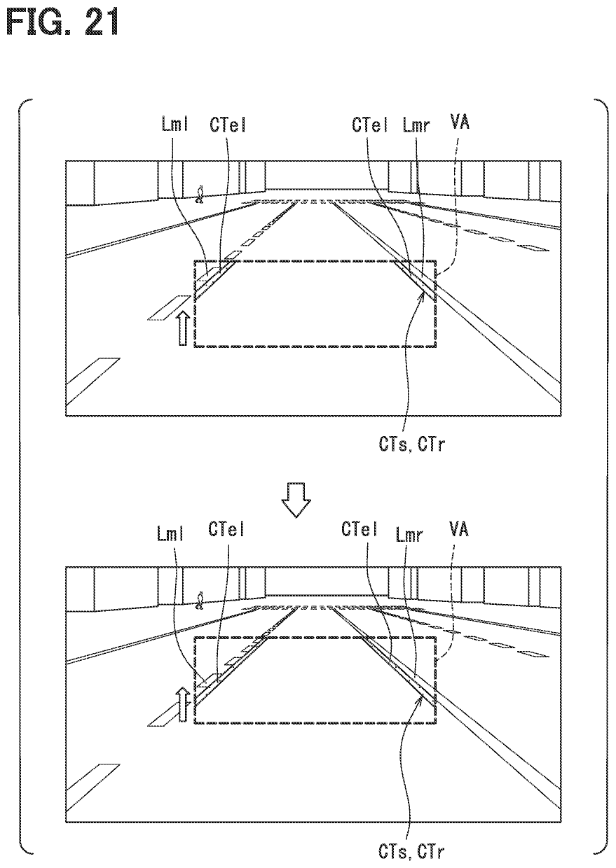

After starting the shift of the view angle VA at time t1, the display control unit 73 starts displaying the lane emphasis content CTel during the shift period TM1 during which the view angle VA shifts (see FIG. 21). The lane emphasis content CTel is the superimposed content CTs displayed as the related content CTr, and is superimposed on the road surface of the own vehicle's lane in the foreground to emphasize the travelling own vehicle's lane. The lane emphasis content CTel is a strip-shaped image arranged inside the left and right lane markings Lml and Lmr (see the upper part of FIG. 21). The lane emphasis content CTel extends along the lane markings Lml and Lmr as the view angle VA shifts upward (see the lower part of FIG. 21). As described above, when the turn-by-turn display is performed, the process of displaying the lane emphasis content CTel as the related content CTr is common to patterns 1 to 4.

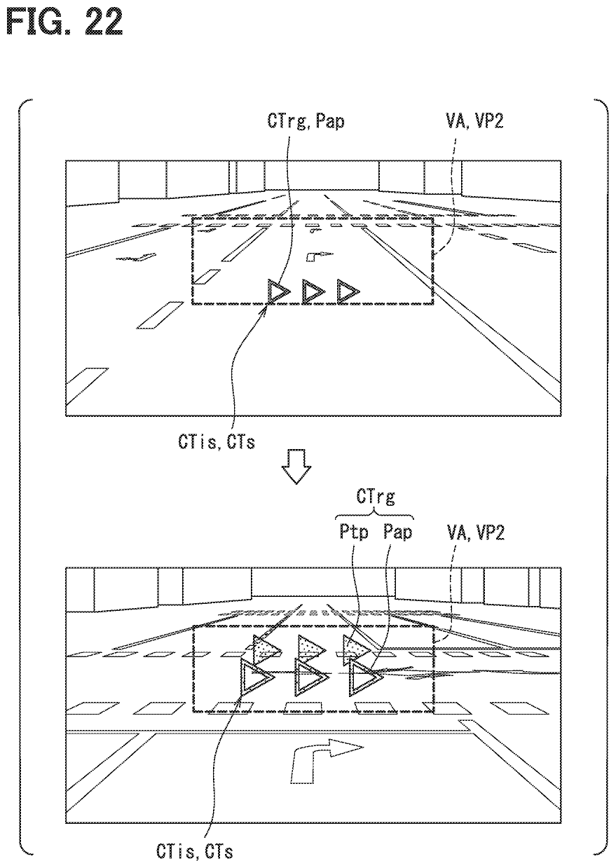

In the turn-by-turn display of pattern 1, when the shift of the view angle VA to the superimposed position VP2 is completed at time t2, the display of the route guidance content CTrg as the specific content CTis is started (see the upper part of FIG. 22). The route guidance content CTrg includes an approach notification image Pap and a point notification image Ptp.

The approach notification image Pap is displayed near the lower edge of the view angle VA at time t2. The approach notification image Pap has a plurality of triangular image portions indicating the turning direction of the own vehicle at the guide point. As the vehicle approaches the guide point, the display control unit 73 enlarges the approach notification image Pap and gradually shifts it to the center of the view angle VA (see the lower part of FIG. 22).

The point notification image Ptp is superimposed and displayed on the guide point in a manner as if it is floating above the road surface. Similar to the approach notification image Pap, the point notification image Ptp has a plurality of triangular image portions indicating the turning direction of the own vehicle. The point notification image Ptp is displayed within the view angle VA after displaying the approach notification image Pap, and shifts to the center of the view angle VA as the vehicle approaches the guide point. The point notification image Ptp collides with the approach notification image Pap shifting upward at the timing when the subject ehicle enters the intersection. The point notification image Ptp and the approach notification image Pap are visually integrated after colliding with each other to form a non-superimposed content CTn that indicates the turning direction of the vehicle to the driver.

When the vehicle leaves the intersection as the guidance point, the display control unit 73 hides the route guidance content CTrg, and then starts shifting the view angle VA to the normal position VP1. The display control unit 73 restarts the display of the speedometer CTv after a predetermined period of time has elapsed after the shift of the view angle VA to the normal position VP1 is completed (see the upper part of FIG. 20).

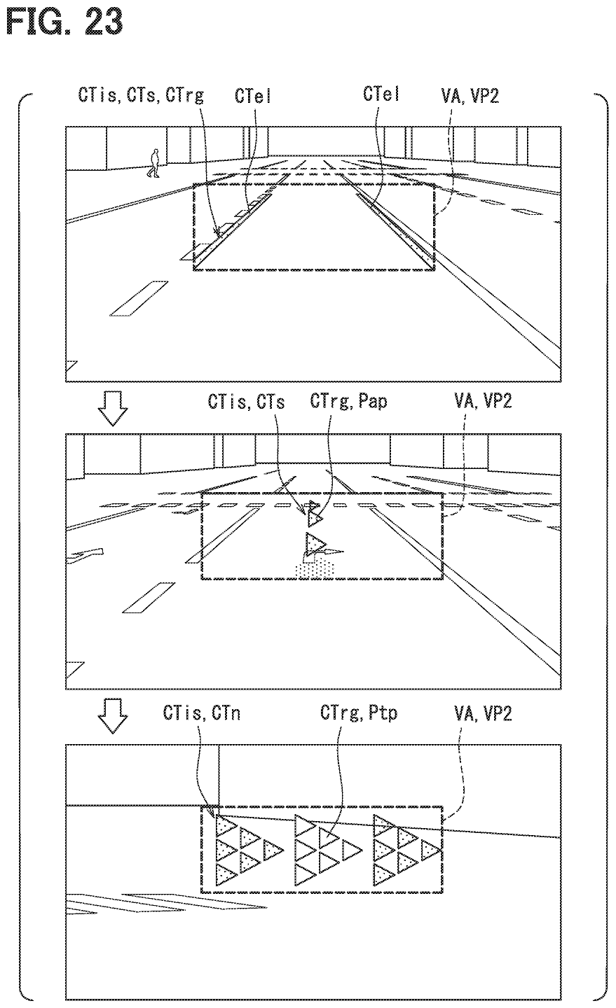

In the turn-by-turn display of pattern 2, the display of the pair of lane emphasis content CTel continues even after the shift of the view angle VA to the superimposed position VP2 is completed at time t2 (see the upper part of FIG. 23). After the lane emphasis content CTel continues to emphasize the own vehicle lane for a predetermined period of time, the display control unit 73 switches the display object included in the route guidance content CTrg from the lane emphasis content CTel to the approach notification image Pap (see the middle of FIG. 23). The approach notification image Pap has a plurality of triangular image portions indicating the turning direction of the own vehicle. A plurality of triangular image portions are superimposed and displayed in a row in the center of the road surface of the own vehicle lane along the traveling direction of the own vehicle. Each image portion continuously shifts below the view angle VA as the vehicle approaches the guidance point, and sequentially goes out of the frame.

The display control unit 73 switches the display object included in the route guidance content CTrg from the approach notification image Pap to the point notification image Ptp at the timing when the own vehicle enters the intersection (see the lower part of FIG. 23). The point notification image Ptp is a non-superimposed content CTn formed by combining a plurality of triangular image portions indicating the turning direction. The point notification image Ptp continues to be displayed until the vehicle exits the intersection even after starting to turn left or right.

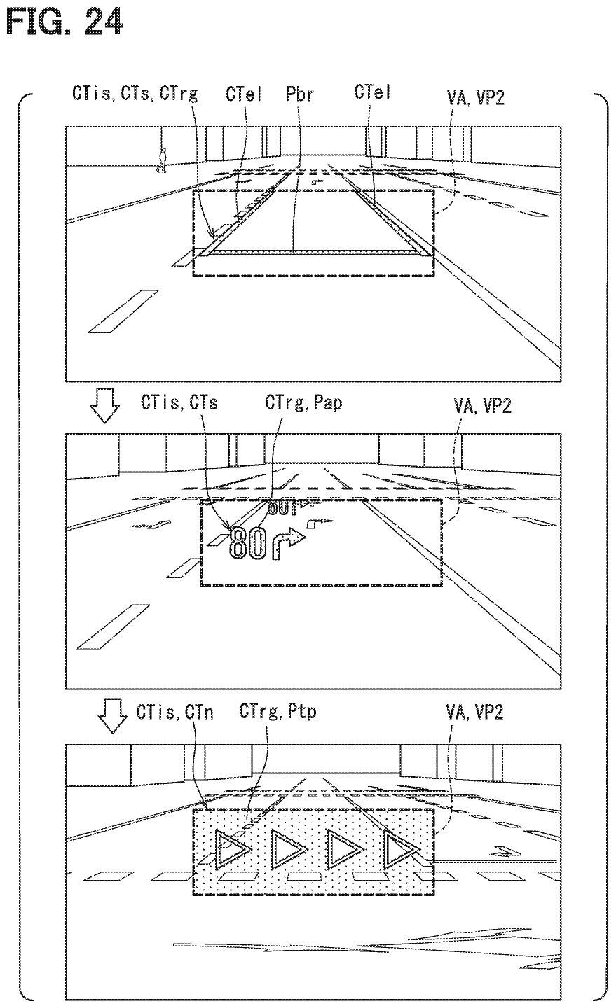

In the turn-by-turn display of pattern 3, after the shift of the view angle VA to the superimposed position VP2 is completed at time t2, the display of the pair of lane emphasis content CTel is continued, and the bar image Pbr is additionally displayed. (see the upper part of FIG. 24). The bar image Pbr is an image extending in a bar shape along the horizontal direction of the view angle VA, and is arranged between a pair of lane emphasis contents CTel.

The display control unit 73 continues emphasizing the lane of the own vehicle with the lane emphasis content CTel and the bar image Pbr for a predetermined time, and then switches the display object included in the route guidance content CTrg to the approach notification image Pap (see the middle part of FIG. 24). The approach notification image Pap has an image portion that numerically indicates the remaining distance to the guide point, and an arrow-shaped image portion that indicates the right and left turn directions at the guidance point. The approach notification image Pap shifts toward the vehicle side along with the road surface as the vehicle approaches the guidance point, and sequentially goes out of the frame from the view angle VA.

The display control unit 73 switches the display object included in the route guidance content CTrg from the approach notification image Pap to the point notification image Ptp at the timing when the guidance point enters the view angle VA (see the lower part of FIG. 24). The point notification image Ptp is a horizontally long rectangular image in which a triangular hole indicating the turning direction is formed. The point notification image Ptp is displayed over substantially the entire of the view angle VA at the superimposed position VP2. The point notification image Ptp continues to be displayed until the vehicle exits the intersection even after the vehicle starts to turn left or right.

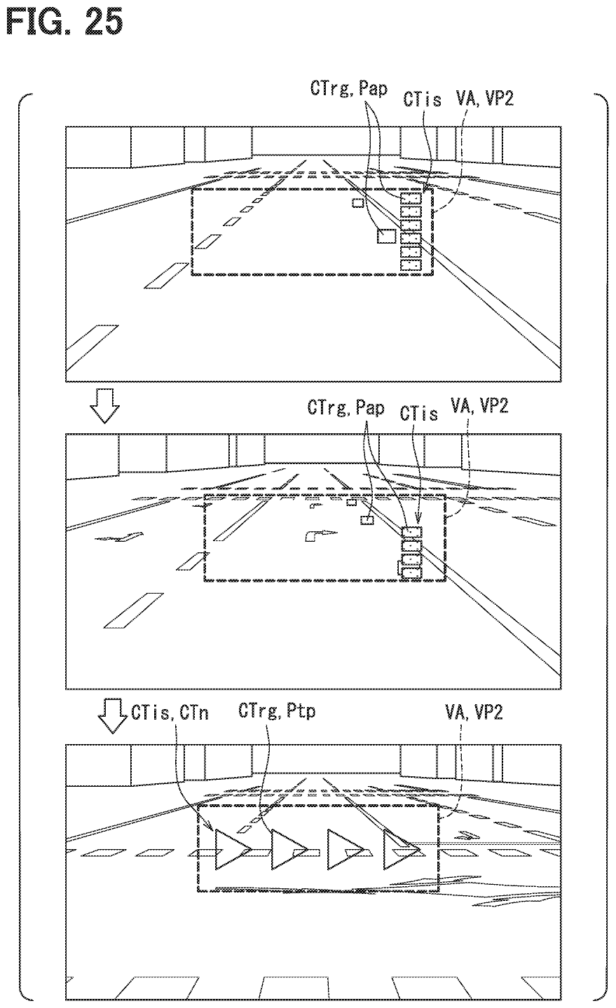

In the turn-by-turn display of pattern 4, after the shift of the view angle VA to the superimposed position VP2 is completed at time t2, display of the route guidance content CTrg including the approach notification image Pap is started. The approach notification image Pap includes a plurality of block-shaped image portions (hereafter, fixed image portions) stacked at the right corner of the view angle VA, and a plurality of block-shaped image portions superimposed on the road surface and approaching the vehicle (hereinafter referred to as a shifting image portions) (see the lower part of FIG. 25). The fixed image portion at the bottom disappears when it collide with the shifting image portion approaching the own vehicle (see the middle part of FIG. 25). By repeating such animation, the approach notification image Pap indicates to the driver that the guidance point is approaching.

The display control unit 73 switches the display object included in the route guidance content CTrg from the approach notification image Pap to the point notification image Ptp at the timing when the guidance point enters the view angle VA (see the lower part of FIG. 25). The point notification image Ptp is the non-superimposed content CTn including a plurality of triangular image portions indicating the turning direction. Even in the turn-by-turn display of pattern 4, the point notification image Ptp continues to be displayed until the vehicle leaves the intersection.

<Traffic Sign Recognition Support Display>

FIGS. 26-31 illustrate several patterns of traffic sign recognition support displays implemented by the display system 110. The related content CTr is not displayed in the traffic sign recognition support display. FIGS. 26 to 28 show the traffic sign recognition support display of pattern 1, and FIGS. 26, 28 and 29 show the traffic sign recognition support display of pattern 2. FIGS. 26, 28 and 30 show a traffic sign recognition support display of pattern3, and FIGS. 26, 28 and 31 show a traffic sign recognition support display of pattern 4.

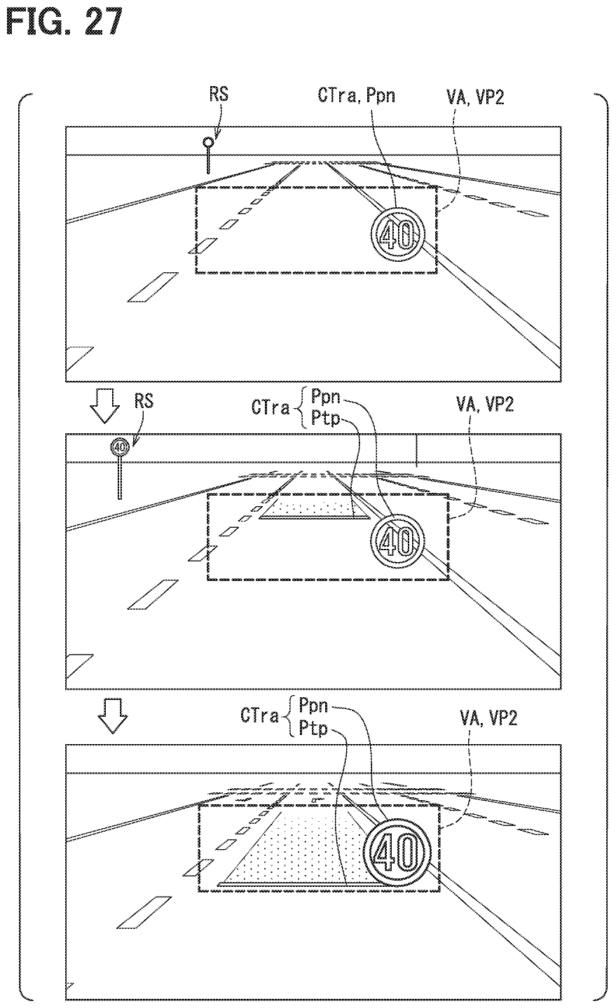

When the traffic sign recognition function of the camera ECU 21 operates, a traffic sign icon CTrs is displayed in addition to the speedometer CTv at the view angle VA at the normal position VP1 (see FIG. 26). The traffic sign icon CTrs is a non-superimposed content CTn representing a previously recognized road sign RS (for example, a speed limit of 60 km/h). When the camera ECU 21 newly detects a road sign RS in front of the vehicle, the camera ECU 21 outputs recognition information about the detected road sign RS to the HUD 100. The display control unit 73 determines execution of the traffic sign recognition support display by using the acquisition of the recognition information of the road sign RS by the information acquisition unit 71 as a trigger. In the traffic sign recognition support display of patterns 1 to 4, content such as the speedometer CTv and the traffic sign icon CTrs or the recognition support content CTra (see FIG. 27) is hidden before the shift of the view angle VA starts at times t1 and t3. In addition, in the traffic sign recognition support display of patterns 1 to 4, the display of all contents is temporarily interrupted during the shift periods TM1 and TM2 of the view angle VA.

In the traffic sign recognition support display of pattern 1, the display of the recognition support content CTra starts within the view angle VA shifted to the superimposed position VP2 at time t2 (see the upper part of FIG. 27). The display control unit 73 first displays the change advance notice image Ppn as the recognition support content CTr. The change advance notice image Ppn is an image imitating the road sign RS, and shows the content of the newly detected road sign RS (for example, the speed limit of 40 km/h). The change advance notice image Ppn is drawn with lower saturation than the traffic sign icon CTrs (see FIG. 26), and is displayed as a virtual image in a size larger than the traffic sign icon CTrs.

When the road sign RS approaches, the display control unit 73 further displays the point notification image Ptp in addition to the change advance notice image Ppn (see the middle part of FIG. 27). The point notification image Ptp is a bar-shaped image extending in the horizontal direction, and superimposed on the road surface in front of the vehicle with reference to the installation position of the road sign RS. The point notification image Ptp approaches the change advance notice image Ppn together with the road surface ahead of the vehicle. The display control unit 73 highlights the change advance notice image Ppn by temporarily increasing the brightness and saturation at the timing when the point notification image Ptp contacts the change advance notice image Ppn (see the lower part of FIG. 27).

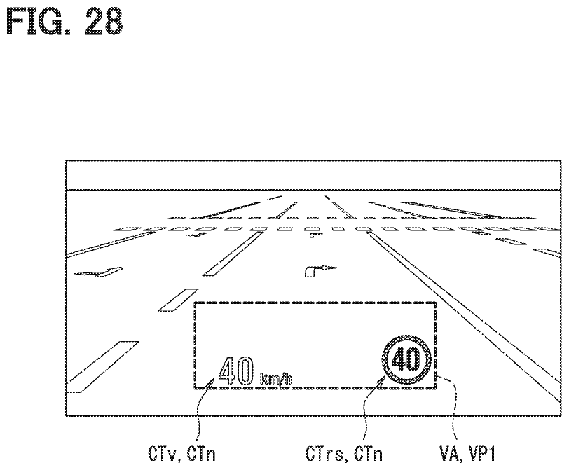

After finishing the display of the recognition support content CTra, the display control unit 73 starts shifting the view angle VA to the normal position VP1 at time t3. After time t4 when the shift of the view angle VA to the normal position VP1 is completed, the display control unit 73 restarts the display of the speedometer CTv and the traffic sign icon CTrs (see FIG. 28). The re-displayed traffic sign icon CTrs has the same content (i.e., the speed limit of 40 km/h) as the previously hidden change advance notice image Ppn.

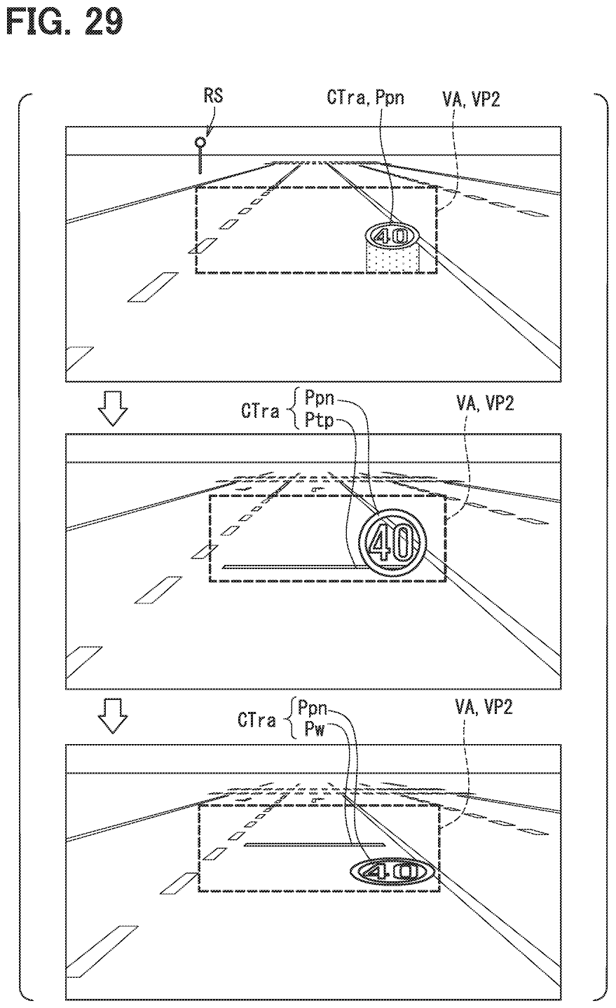

In the traffic sign recognition support display of Pattern 2, the display of the recognition support content CTra is started by an animation in which the change advance notice image Ppn frames in from the lower edge of the view angle VA shifted to the superimposed position VP2 (see the upper part of FIG. 29). As in pattern 1, the display control unit 73 further displays the point notification image Ptp, and then causes the point notification image Ptp to collide with the change advance notice image Ppn (see the middle part of FIG. 29). After the point notification image Ptp and the change advance notice image Ppn are brought into contact with each other, the display control unit 73 tilts the change advance notice image Ppn toward the back side while it is in the emphasized state, and changes the posture to stick to the road surface (see the lower part of FIG. 29).

In addition, the display control unit 73 displays the ripple image Pw instead of the point notification image Ptp. The ripple image Pw is a bar-shaped image extending in the horizontal direction, and is superimposed and displayed on the road surface of the own vehicle lane. The ripple image Pw suggests a section in which the new road sign RS becomes effective by shifting at high speed in the direction of travel along the lane of the vehicle. The display control unit 73 ends the display of the recognition support content CTr at the timing when the ripple image Pw frames out from the view angle VA, and starts the process of returning the view angle VA to the normal position VP1.

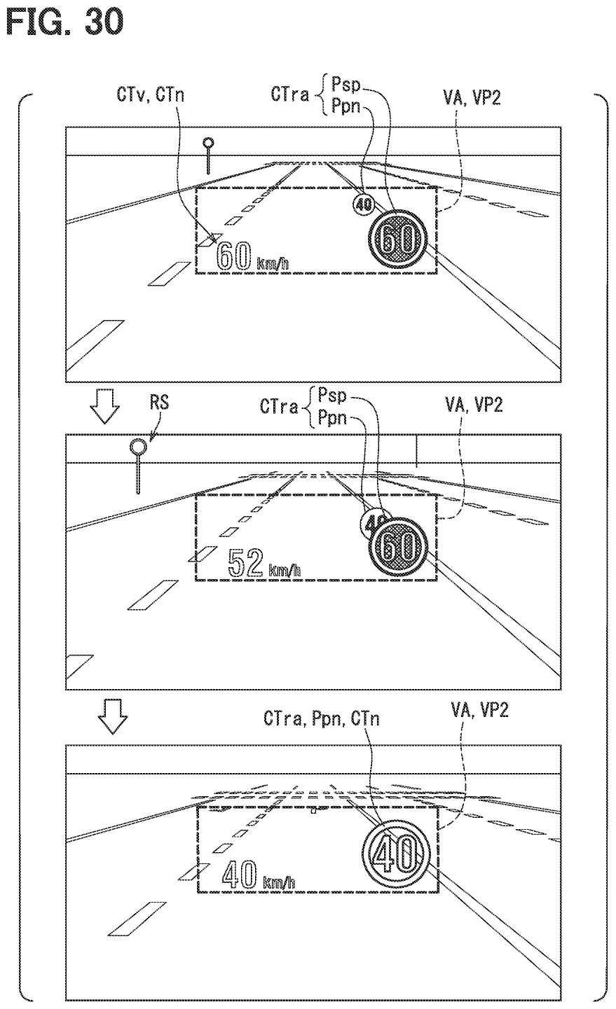

In the traffic sign recognition support display of pattern 3, the speedometer CTv is displayed in addition to the recognition support content CTra within the view angle VA shifted to the superimposed position VP2. The recognition support content CTr includes a change advance notice image Ppn and a current traffic sign image Psp. The change advance notice image Ppn is displayed behind the current traffic sign image Psp (see the upper part of FIG. 30). The change advance notice image Ppn shifts toward the subject vehicle side together with the road surface in front of the vehicle, and approaches the current traffic sign image Psp (see the middle part of FIG. 30).

The current traffic sign image Psp is an image imitating the road sign RS, similar to the change advance notice image Ppn (see the upper part of FIG. 30). The current traffic sign image Psp shows the same content (i.e., the speed limit of 60 km/h) as the previously hidden traffic sign icon CTrs (see FIG. 28). The current traffic sign image Psp is displayed at a predetermined position within the view angle VA on the front side of the change advance notice image Ppn.

The display control unit 73 causes the change advance notice image Ppn moving toward the subject vehicle to collide with the current traffic sign image Psp, and terminates the display of the current traffic sign image Psp (see the lower part of FIG. 30). The display control unit 73 displays, as the non-superimposed content CTn, the change advance notice image Ppn in an emphasis manner with the enhanced brightness and saturation, instead of the current traffic sign image Psp. After that, the display control unit 73 ends the display of the recognition support content CTr and starts shifting the view angle VA to the normal position VP1.

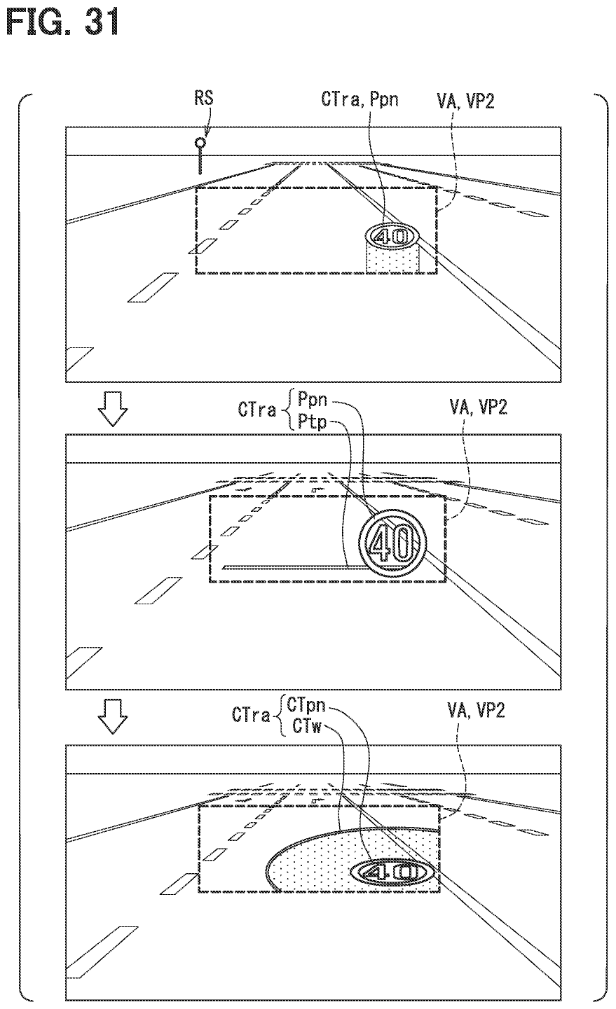

In the sign recognition support display of pattern 4, the change advance notice image Ppn and the point notification image Ptp that are substantially the same as pattern 2 are displayed as the recognition support content CTr (see the upper and middle parts of FIG. 31). Pattern 4 differs from pattern 2 in the feature of the ripple image Pw. Specifically, the display control unit 73 tilts the change advance notice image Ppn to the back side, and then displays an arc-shaped ripple image Pw that radially spreads from the change advance notice image Ppn (see the lower part of FIG. 31). The display control unit 73 repeatedly displays the animation in which the ripple image Pw spreads from the change advance notice image Ppn as a starting point a plurality of times, and then terminates the display of the recognition support content CTra.

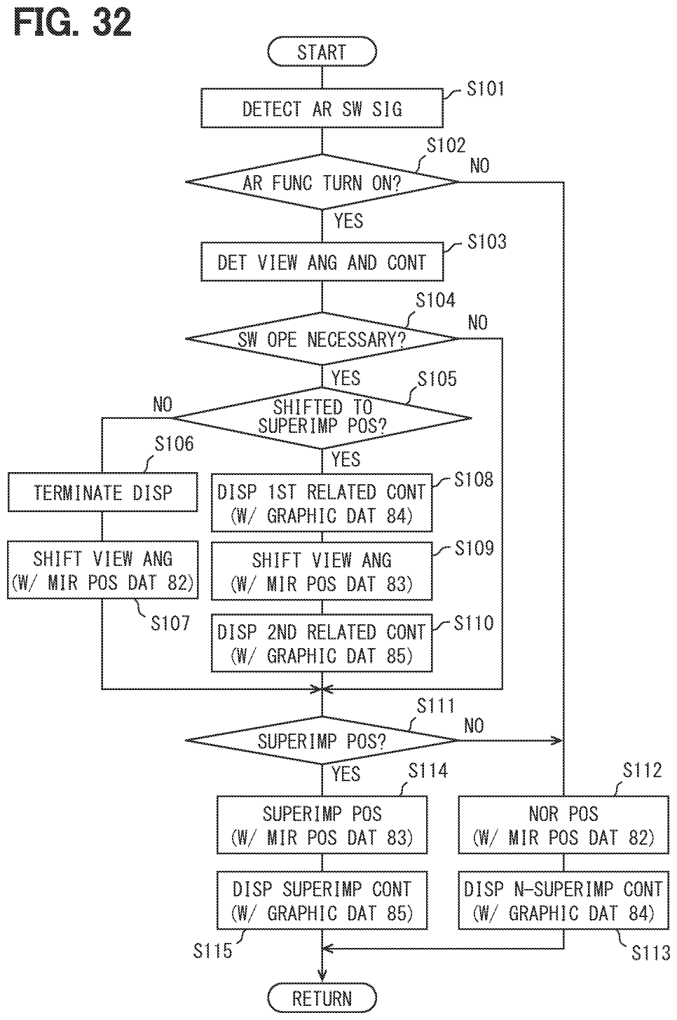

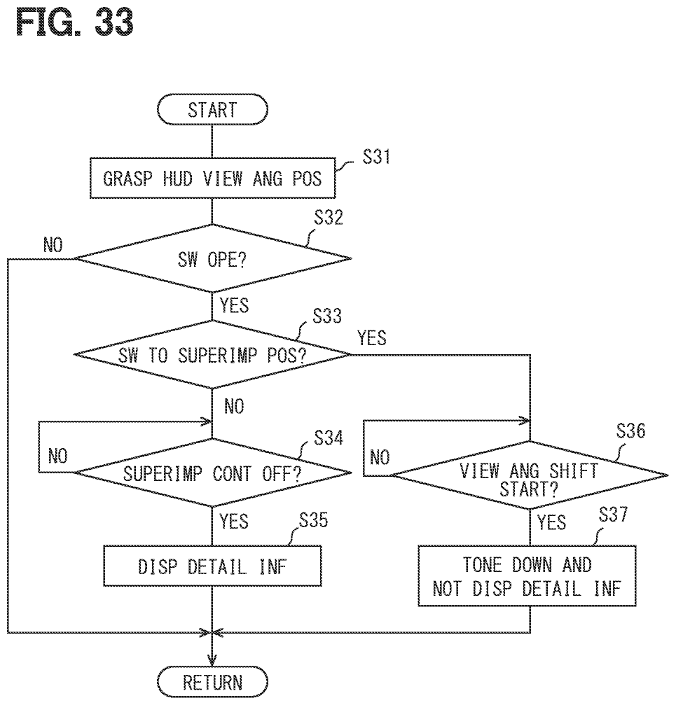

The details of the display control processing for realizing the virtual image display method described above will be described based on FIGS. 32 and 33 with reference to FIGS. 1 and 4. The display control process shown in FIG. 32 is a process of displaying content in association with the position of the view angle VA, and is started by the head-up ECU 70 that has completed the initial process after activation. The display control process shown in FIG. 33 is a process of changing the state of the detailed information PDi on the display screen in accordance with the shift of the view angle VA by the HUD 100, and is started by the meter ECU 32 that has completed the initial process after activation.

In S101 of the display control process shown in FIG. 32, a signal indicating the on and off state of the AR switch 68 is detected, and the process proceeds to S102. In S102, based on the signal detected in S101, it is determined whether or not the AR function for displaying the superimposed content CTs within the view angle VA shifted to the superimposed position VP2 is in the on state. If it is determined in S102 that the AR function is in the off state, the process proceeds to S112. On the other hand, if it is determined in S102 that the AR function is in the on state, the process proceeds to S103.

In S103, the position of the view angle VA and the content to be displayed as a virtual image are determined by referring to the lookup table 81 based on various information acquired by the information acquisition unit 71, and the process proceeds to S104. In S104, based on the determination in S103, it is determined whether or not the switching operation for switching the position of the view angle VA is necessary. If it is determined in S104 that the switching operation is unnecessary and the current view angle position is to be maintained, the process proceeds to S111. On the other hand, when it is determined in S104 that the switching operation is necessary, the process proceeds to S105.

In S105, the direction of the switching operation is determined. When shifting the view angle VA from the superimposed position VP2 to the normal position VP1, the process proceeds from S105 to S106. In S106, all of the display of the virtual image Vi is terminated, and the process proceeds to S107. In S107, based on the mirror position data 82 linked to the normal position VP1, the concave mirror of the magnifying optical system 62 is rotated to shift the view angle VA to the normal position VP1.

On the other hand, when shifting the view angle VAfrom the normal position VP1 to the superimposed position VP2, the process proceeds from S105 to S108. In S108, the graphic data 84 is referenced, the display of the first related content CTr1 is started, and the process proceeds to S109. In S109, based on the mirror position data 83 linked to the superimposed position VP2, the concave mirror is rotated to start shifting the view angle VA to the superimposed position VP2, and the process proceeds to S110. In S110, the graphic data 85 is referenced, the display of the second related content CTr2 is started, and the process proceeds to S111. Note that if there is no first related content CTr1 linked to the specific content CTis, S108 may be omitted. Similarly, if there is no second related content CTr2 linked to the specific content CTis, S110 may be omitted.

In S111, the view angle position is determined. If it is determined in S111 that the normal position VP1 is maintained or the shift to the normal position VP1 is completed, the process proceeds to S112. In S112, the view angle VA is set to the normal position VP1 based on the mirror position data 82, and the process proceeds to S113. In S113, the graphic data 84 is referenced, and display of the non-superimposed content CTn determined in S103 is started. Incidentally, if the mirror position data 82 of the normal position VP1 has already been read in S107, S112 may be omitted.

On the other hand, if it is determined in S111 that the superimposed position VP2 is maintained or the shift to the superimposed position VP2 is completed, the process proceeds to S114. In S114, the view angle VA is set to the superimposed position VP2 based on the mirror position data 83, and the process proceeds to S115. In S115, the graphic data 85 is referenced, and display of the superimposed content CTs determined in S103 is started. Incidentally, if the mirror position data 83 of the superimposed position VP2 has already been read in S109, S114 may be omitted.

In S31 of the display control process shown in FIG. 33, the position of the view angle VA set in the HUD 100 is grasped by sharing information with the head-up ECU 70, and the process proceeds to S32. In S32, based on the information ascertained in S31, the presence or absence of switching operation of the view angle position is ascertained. If it is determined in S32 that the view angle position is maintained, the current display state or the current hidden state of the detailed information PDi is maintained. In addition, in the initial processing after activation, processing for starting display of the detailed information PDi may be appropriately performed.

When it is determined in S32 that there is a switching operation, the process proceeds to S33. In S33, the shift direction of the view angle VA is determined. When it is determined in S33 that the view angle VA is shifted to the normal position VP1, the process proceeds to S34. In S34, the HUD 100 stands by until the display of the superimposed content CTs is turned off, and proceeds to S35 at the timing when the superimposed content CTs becomes in the hidden state. In S35, display of detailed information PDi is started. As described above, during the period when the view angle VA is at the normal position VP1, the detailed information PDi is displayed on the display screen so that the driver can check it at any time.

When it is determined in S33 that the view angle VA is shifted to the superimposed position VP2, the process proceeds to S36. In S36, the process stands by for the start of shift of the view angle VA, and proceeds to S37 at the timing when the shift of the view angle VA is started. At S37, tone down of the detailed information PDi is started. As a result, during the shift period TM1 of the view angle VA from the normal position VP1 to the superimposed position VP2, the mode change is performed to reduce the visibility of the detailed information PDi. In addition, in S37, the detailed information PDi is hidden at the timing when the shift of the view angle to the superimposed position VP2 is completed by continuing the tone down.

According to the first embodiment described so far, the related content CTr related to the specific content CTis is displayed before the shift of the view angle VA from the normal position VP1 to the superimposed position VP2 is completed. Therefore, the time lag until the start of display due to the shift of the view angle VA by the actuator 63 is less likely to be perceived by the occupants of the vehicle A such as the driver. Therefore, even if the actuator 63 is provided to extend the view angle VA in which the virtual image can be displayed, the discomfort of the display can be reduced. As a result, it becomes possible to enhance the convenience of the HUD 100.

In particular, when presenting information using the superimposed content CTs in a scene of high urgency, reducing the time lag is essential for prompt start of notification. Therefore, the process of quickly displaying the related content CTr with respect to the specific content CTis can effectively improve the convenience of virtual image display.

In addition, in the first embodiment, display of the related content CTr (i.e., the first related content CTr1) starts before time t1 (see FIG. 4) at which the actuator 63 starts shifting the view angle VA. As an example, with the implementation of the lane departure warning, the blinking background CTB is displayed as the related content CTr before the view angle VA starts shifting. Since such related content CTr starts to be displayed immediately after the switching of the view angle position is determined, the delay in the display perceived by the driver can be reduced. As a result, the driver is more likely to feel that the system on the vehicle side is operating normally.

Further, in the first embodiment, the second related content CTr2 that is different from the first related content CTr1 is displayed while the actuator 63 is shifting the view angle VA (i.e., in the shift period TM1, see FIG. 4). As an example, with the implementation of the lane departure warning, after the blinking background CTB is displayed, the guidance contents CTGn and CTGs are displayed as the second related contents CTr2 within the view angle VA during the shift. By displaying the first related content CTr1 and the second related content CTr2 in different modes at different view angle positions, the driver's line of sight can be guided toward the superimposed position VP2 where the specific content CTis is displayed. As a result, the driver can smoothly perceive the specific content CTis, so that highly convenient virtual image display is realized.

Furthermore, in the first embodiment, the display of the related content CTr is started while the actuator 63 is shifting the view angle VA (i.e., in the shift period TM1, see FIG. 4). As an example, with the implementation of the ACC status change notification, the partial display content CTus is displayed as the related content CTr within the view angle VA during shift. Since such related content CTr is visually recognized continuously with the specific content CTis displayed at the superimposed position VP2, it can exhibit the effect of gently guiding the driver's line of sight to the specific content CTis. As a result, the driver can smoothly perceive the specific content CTis, so that highly convenient virtual image display is realized.

In addition, in the first embodiment, the superimposed position VP2 is defined above the normal position VP1, and the display control unit 73 superimposes and displays the specific content CTis on the object in the foreground. According to such operation of the HUD 100, the highly attractive superimposed content CTs can be displayed at an appropriate timing at a position easily perceived by the driver. Therefore, it is possible to present information that is easy for the driver to understand and that is less annoying.

On the other hand, the normal position VP1 is arranged downward. Since the superimposed content CTs is not displayed at the normal position VP1, the information density at the normal position VP1 can be appropriately suppressed. According to the above, when the view angle VA is at the normal position VP1, information is presented in a way that is less annoying.

Further, in the first embodiment, when the departure warning content CTdw for warning the departure of the vehicle A is displayed as the specific content CTis, the guidance content CTGn that visually shifts along the driver's line of sight in accordance with the shift of the view angle VA is displayed as the related content CTr. Such guidance content CTGn can preliminarily guide the driver's line of sight to the superimposed position VP2 by visually shifting the virtual image Vi with a simple shape. As a result, the departure warning content CTdw is easily perceived, and highly convenient virtual image display is realized.

Furthermore, in the first embodiment, when the departure warning content CTdw is displayed as the specific content CTis, the guidance content CTGs shifting toward the vanishing point during the shift period TM1 of the view angle VA is displayed as the related content CTr. Such guidance content CTGs may direct the driver's line of sight far into the foreground. As a result, the departure warning content CTdw displayed at the superimposed position VP2 can be visually recognized smoothly. Therefore, it is possible to display a virtual image with high convenience.

In addition, in the first embodiment, when the inter-vehicle distance notification content CTfd is displayed as the specific content CTis, the partial display content CTus, which is a part of the inter-vehicle distance notification content CTfd, is displayed as the related content CTr within the view angle VA of the shift period TM1. The partial display content CTus can exhibit a visual effect such that display of the inter-vehicle distance notification content CTfd is started before the shift of the view angle VA is completed. As a result, the time lag from when the set value of the adaptive cruise control is changed to when the inter-vehicle distance notification content CTfd is displayed is reduced. When the response of the display system 110 perceived by the driver is enhanced in this way, the driver can easily recognize that the system of the vehicle A is responding appropriately.

Further, in the first embodiment, when the route guidance content CTrg for route guidance is displayed as the specific content CTis, the lane emphasis content CTel for emphasizing the current travelling lane of the subject vehicle is displayed as the related content CTr. Such lane emphasis content CTel can show the future movement trajectory of the subject vehicle in cooperation with the route guidance content CTrg. As a result, easy-to-understand route guidance using the expanded view angle VA can be implemented, so that the convenience of virtual image display is further improved.

Furthermore, according to the display system 110 according to the first embodiment, the meter display device 30 changes the display on the display screen in cooperation with the switching of the position of the view angle VA by the actuator 63. Such cooperation between the virtual image display and the screen display makes it possible to make the driver's line of sight appropriately directed to the foreground while facilitating information acquisition by the driver. Therefore, highly convenient information presentation is realized.

In addition, in the first embodiment, the detailed information PDi related to the specific content CTis is displayed on the display screen while the view angle VA is disposed at the normal position VP1. Then, when the shift of the view angle VA to the superimposed position VP2 is completed, the detailed information PDi is hidden. In this way, if the detailed information PDi is temporarily hidden, it is less likely that the detailed information PDi will attract the driver's attention and prevent the driver from grasping the content displayed at the superimposed position VP2 and the situation ahead. Therefore, it becomes easier to ensure the convenience of the driver.

Further, in the first embodiment, during the shift period TM1 during which the view angle VA shifts from the normal position VP1 to the superimposed position VP2, the mode change is performed to reduce the visibility of the detailed information PDi. As a result, even if the driver's attention is focused on the detailed information PDi, the driver's line of sight is naturally diverted from the detailed information PDi due to the mode change that reduces visibility, and the driver's line of sight can be guided to the virtual image display. As a result, it is possible to prompt the driver to grasp the situation in front of the vehicle at an appropriate timing.

In the first embodiment, the guidance contents CTGn and CTGs correspond to “moving contents”, the partial display contents CTus correspond to “a part (of the inter-vehicle distance notification contents)”, and the normal position VP1 corresponds to the “first position”, and the superimposed position VP2 corresponds to the “second position”. The meter display device 30 corresponds to the “screen display device”, the actuator 63 corresponds to the “switching mechanism”, and the HUD 100 corresponds to the “virtual image display device”.

### Second Embodiment

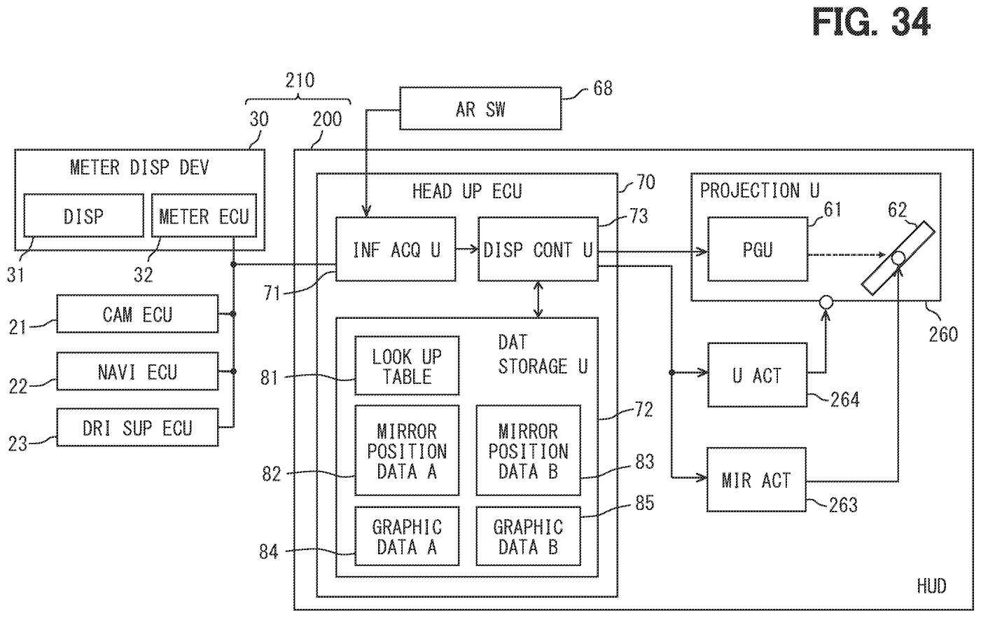

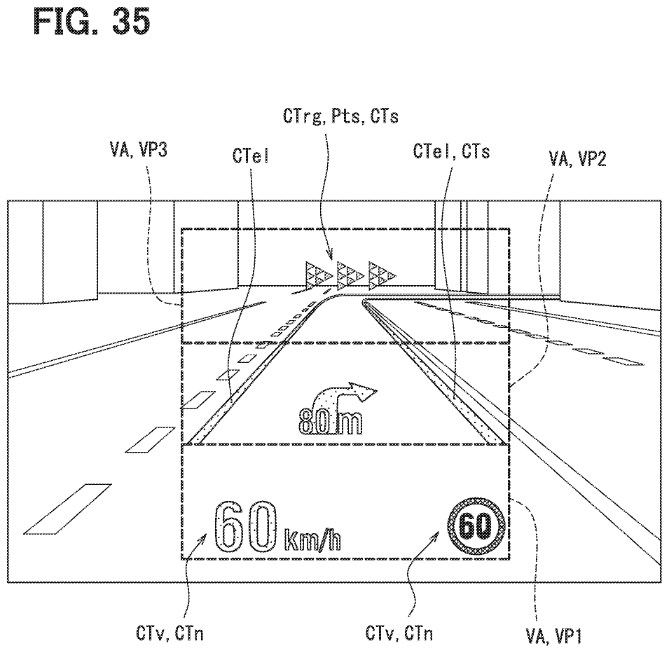

A second embodiment of the present disclosure illustrated in FIGS. 34 and 35 is a modification of the first embodiment. A display system 210 of the second embodiment is configured by the meter display device 30, the HUD 200, and the like. The function of outputting image data used for virtual image display to the HUD 200 is omitted from the meter display device 30 of the second embodiment. Image data used for virtual image display are all generated by the head-up ECU 70.

The HUD 200 includes a projection unit 260, a mirror actuator 263 and an unit actuator 264. The projection unit 260 is configured to integrally include the PGU 61 and the magnifying optical system 62. The projection unit 260 is supported by the housing of the HUD 200 so as to be vertically movable in the emission direction of the virtual image light Lvi (see FIG. 1).

The mirror actuator 263 and the unit actuator 264 have a configuration corresponding to the actuator 63 (see FIG. 2) of the first embodiment, and has a mechanism for mechanically moving the projection range PA as a part of the windshield WS (see FIG. 1). The mirror actuator 263 is a mechanism incorporated in the projection unit 260 and rotates the concave mirror of the magnifying optical system 62 around the rotation axis defined for the concave mirror. The unit actuator 264 rotates the entire projection unit 260 with respect to the housing of the HUD 200 around the rotation axis defined in the projection unit 260. The mirror actuator 263 and the unit actuator 264 cooperate with each other to change the emission direction of the virtual image light Lvi from the magnifying optical system 62 toward the windshield WS.

The HUD 200 switches the position of the view angle VA among the three according to the attitude change of the projection unit 260 and the magnifying optical system 62 in the projection unit 260. The HUD 200 can shift the view angle VA to a distant position VP3 defined above the superimposed position VP2, in addition to the normal position VP1 and the superimposed position VP2, which are substantially the same as those in the first embodiment. Also in the second embodiment, the normal position VP1, the superimposed position VP2, and the distant position VP3 may be adjustable according to the driver's body shape and the like through user operation by the driver.

The non-superimposed content CTn is mainly displayed at the normal position VP1. As an example, a speedometer CTv and a traffic sign icon CTrs are displayed at the normal position VP1. Substantially no superimposed content CTs is displayed at the normal position VP1. On the other hand, the superimposed content CTs is mainly displayed at the superimposed position VP2 and the distant position VP3. As an example, at the superimposed position VP2 and the distant position VP3, the lane emphasis content CTel, the route guidance content CTrg, and the like are displayed. In particular, for example, the point notification image Ptp is superimposed on the distant position VP3.

When shifting the view angle VA from the normal position VP1 to the superimposed position VP2 or the distant position VP3, the head-up ECU 70 displays the related content CTr preliminarily associated with the specific content CTis, as in the first embodiment (see FIGS. 21 and 23). In addition, the head-up ECU 70 can display the related content CTr also when shifting from the superimposed position VP2 to the distant position VP3.

As described above, the second embodiment has the same effect as the first embodiment, and the driver hardly perceives the time lag until the start of display due to the shift of the view angle by the actuators 263 and 264. Therefore, even if the view angle VA at which the virtual image can be displayed is expanded, the discomfort of the display is reduced, so that the convenience of the HUD 200 can be enhanced.

In addition, the HUD 200 of the second embodiment can shift the view angle VA to the distant position VP3 in addition to the normal position VP1 and the superimposed position VP2. According to the above, since the virtual image displayable range can be further expanded, the convenience of the HUD 200 can be further improved. Here, in the second embodiment, the mirror actuator 263 and the unit actuator 264 correspond to the “switching mechanism”, and the HUD 200 corresponds to the “virtual image display device”.

### Third Embodiment

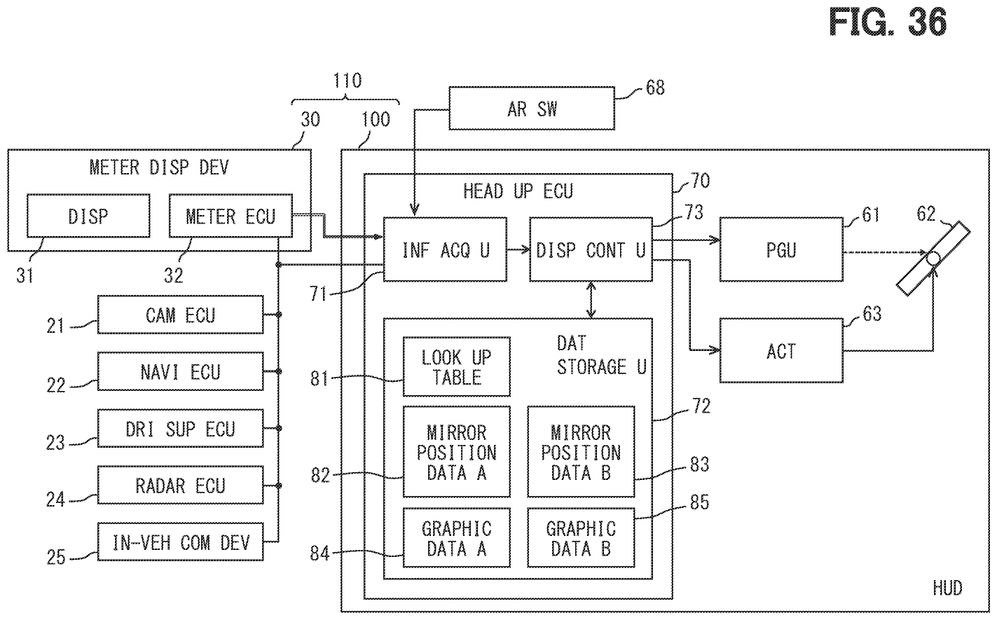

A third embodiment of the present disclosure shown in FIGS. 36 to 50 is another modification of the first embodiment. In the third embodiment, in addition to the camera ECU 21, the navigation ECU 22, the driving support ECU 23, and the like, the radar ECU 24 and the in-vehicle communication device 25 are further connected to the communication bus of the in-vehicle network to which the HUD 100 and the meter display device 30 are connected.

The radar ECU 24 is a circuit device mainly including a signal processing circuit included in the radar unit, and is electrically connected to an antenna that transmits and receives millimeter waves or quasi-millimeter waves. The radar unit is mounted on the vehicle A (see FIG. 1) in the same manner as the in-vehicle camera (i.e., the front camera), such that the radar unit has the arrangement and the posture with the detection range in front of the vehicle. The radar ECU 24 detects the relative position (i.e., the distance and the direction) and relative speed of a target obstacle existing in front of the vehicle by receiving reflected waves of millimeter waves or quasi-millimeter waves emitted in front of the vehicle. The radar ECU 24 provides the driving support ECU 23 with information indicating the detected relative position and the relative speed of the target obstacle as detection information of the forward target obstacle. A plurality of radar units may be mounted on the vehicle A in such a posture that the detection range is the front side, the rear side, and the back side of the subject vehicle. Furthermore, the vehicle A may be equipped with autonomous sensors such as lidar and sonar other than cameras and millimeter wave radars.

The in-vehicle communication device 25 is an external communication unit mounted on the vehicle A and functions as a V2X (Vehicle to Everything) communication device. The in-vehicle communication device 25 transmits and receives information to and from a roadside device installed on the side of the road by wireless communication. The in-vehicle communication device 25 receives target obstacle information indicating the position and moving speed of a moving target obstacle entering the intersection from a roadside device installed at the intersection. Specifically, the in-vehicle communication device 25 receives target obstacle information regarding vehicles, motorcycles, cyclists, pedestrians, and the like entering the intersection. The in-vehicle communication device 25 provides the received target obstacle information to the driving support ECU 23.

The in-vehicle communication device 25 receives the position information of the vacant parking space PkS (hereinafter referred to as parking space information) from the roadside unit installed on the side of the road where on-street parking is allowable or the roadside unit installed in the parking lot of a facility (for example, a shopping mall). If the use of the parking space PkS is managed by a specific management center, the in-vehicle communication device 25 may be able to reserve the parking space PkS in cooperation with the navigation ECU 22. The in-vehicle communication device 25 provides the parking space information received from the roadside device to the navigation ECU 22 and the driving support ECU 23.

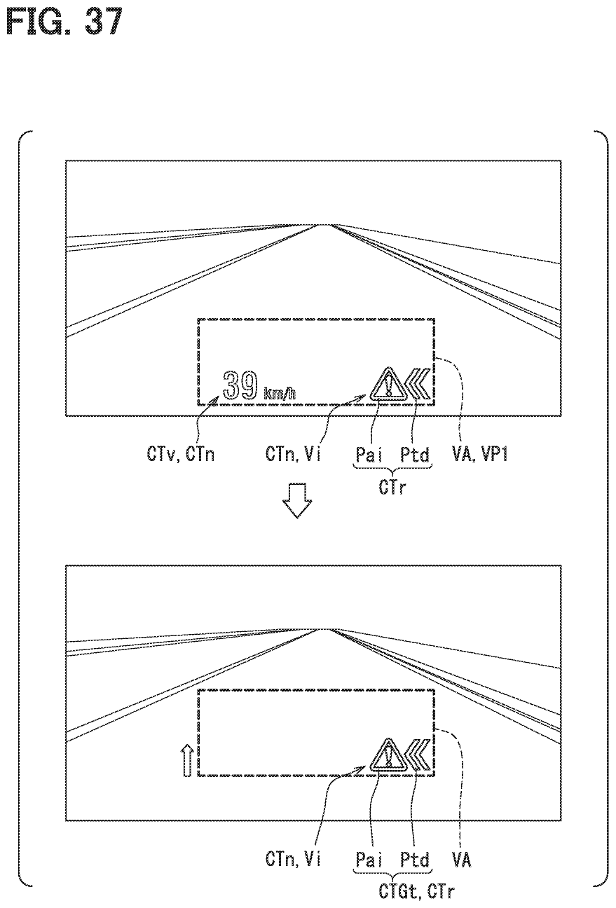

Next, details of the specific content CTis and the related content CTr displayed by the display system 110 of the third embodiment will be described. The display system 110 provides forward target obstacle warning, parking space guidance, narrow road driving support display, and visibility support display in addition to lane departure warning, ACC status change notification, turn-by-turn display, and the like, similar to the first embodiment. Next, a plurality of scenes in which the specific content CTis is displayed by shifting the view angle VA from the normal position VP1 to the superimposed position VP2 will be described below based on FIGS. 37 to 50 and with reference to FIGS. 36 and 1.

<Front Target Obstacle Warning>

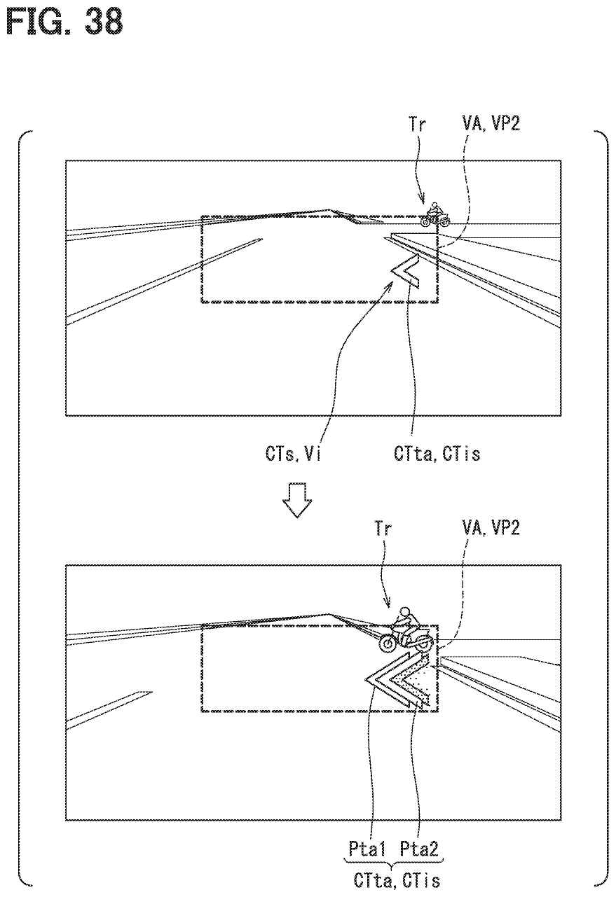

In the forward target obstacle warning shown in FIGS. 37 and 38, the driver is warned of the presence of a forward risk target obstacle Tr approaching the vehicle A. The risk target obstacles Tr to be warned are other vehicles, motorcycles, cyclists, pedestrians, Nd the like recognized by the driving support ECU 23. Forward target obstacle warning is performed based on the detection of the risk target obstacle Tr by the driving support ECU 23.

The driving support ECU 23 recognizes moving target obstacles in front of the vehicle based on detection information acquired from the camera ECU 21 and the radar ECU 24 and target obstacle information acquired through the in-vehicle communication device 25 and the like. Among the recognized moving target obstacles, the driving support ECU 23 selects a moving target obstacle that is approaching vehicle A (i.e., the subject vehicle) and whose estimated travel trajectory intersects the estimated travel trajectory of the subject vehicle as a risk target obstacle Tr. When the risk target obstacle Tr is detected, the driving support ECU 23 provides the head-up ECU 70 and the meter ECU 32 with risk target obstacle information indicating that the risk target obstacle Tr has been detected and the relative position of the risk target obstacle Tr. Note that the driving support ECU 23 may be capable of providing risk target obstacle information about each risk target obstacle Tr when a plurality of risk target obstacles Tr are detected.

The display control unit 73 displays the speedometer CTv, which is the non-superimposed content CTn, at the view angle VA at the normal position VP1 before the forward target obstacle warning is started (see the upper part of FIG. 5). The display control unit 73 determines execution of the forward target obstacle warning, triggered by the acquisition of the risk target obstacle information by the information acquisition unit 71.

When determining to execute the foreground target obstacle warning, the display control unit 73 displays the warning image Pai and the direction presentation image Ptd while continuing to display the speedometer CTv (see the upper part of FIG. 37). The warning image Pai and the direction presentation image Ptd are non-superimposed contents CTn displayed near the lower edge of the view angle VA in an arrangement manner arranged with the speedometer CTv in the right-left direction. The warning image Pai and the direction presentation image Ptd are displayed as the related content CTr in the forward target obstacle warning.

The warning image Pai is displayed as a virtual image in a warning color such as yellow. The warning image Pai is an image for notifying the driver that the risk target obstacle Tr has been sensed and for giving the driver notice. The warning image Pai is an image mainly including an exclamation mark. When the type of the risk target obstacle Tr is not identified by the driving support ECU 23, it may be desirable that the warning image Pai is in a mode that does not remind the user of the type of the risk target obstacle Tr. Note that if the driving support ECU 23 can determine the type of the risk target obstacle Tr with high accuracy, the mode of the warning image Pai may be appropriately changed to a mode that indicates the type of the risk target obstacle Tr.

The direction presentation image Ptd is displayed as a virtual image in substantially the same display color (e.g., yellow) as the warning image Pai. The direction presentation image Ptd is combined with the warning image Pai to notify the direction in which the risk target obstacle Tr is approaching and the movement direction of the risk target obstacle Tr. When the risk target obstacle Tr is approaching from the right front of the subject vehicle, the direction presentation image Ptd is drawn in a V shape pointing leftward and displayed on the right side of the warning image Pai. On the other hand, when the risk target obstacle Tr is approaching from the left front of the subject vehicle, the direction presentation image Ptd is drawn in a V shape pointing to the rightward and displayed on the left side of the warning image Pai.

The display control unit 73 terminates the display of the speedometer CTv before starting the shift of the view angle VA at time t1 (see FIG. 4). When starting to shift the view angle VA, the display control unit 73 uses the already displayed warning image Pai and direction presentation image Ptd as the guidance content CTGt (see the lower part of FIG. 37). The guidance content CTGt guides the line of sight of the driver to the risk target obstacle Tr by shifting toward the risk target obstacle Tr in the foreground during the shift of the view angle VA (in the shift period TM1, see FIG. 4). Such guidance content CTGt may be the non-superimposed content CTn or the superimposed content CTs.

The display control unit 73 reduces the display size of the guidance content CTGt toward the center side of the view angle VA in accordance with the upward shift of the view angle VA. As a result, the center of the guidance content CTGt slightly shifts toward the center of the view angle VA as the view angle VA shifts upward. The display control unit 73 hides the guidance content CTGt before the shift of the view angle VA to the superimposed position VP2 is completed. As described above, the guidance content CTGt that will shift toward the vanishing point in the foreground and then disappear is displayed.

Here, the display control unit 73 may change the shift direction of the guidance content CTGt during the shift period TM1 according to the right left direction of the risk target obstacle Tr. For example, when the risk target obstacle Tr is approaching from the right front of the subject vehicle, the display control unit 73 shifts the display position of the guidance content CTGt to the right of the view angle VA during the shift period TM1. On the other hand, when the risk target obstacle Tr is approaching from the left front of the subject vehicle, the display control unit 73 shifts the display position of the guidance content CTGt to the left of the view angle VA during the shift period TM1. According to the above, the guidance content CTGt can accurately guide the driver's line of sight toward the risk target obstacle Tr.

After completing the shift of the view angle VA to the superimposed position VP2 at time t2 (see FIG. 4), the display control unit 73 starts displaying the target obstacle warning content CTta (see the upper part of FIG. 38). The target obstacle warning content CTta is the specific content CTis in the forward target obstacle warning. The target obstacle warning content CTta is a superimposed content CTs that is superimposed on the risk target obstacle Tr in the foreground, and warns the risk target obstacle Tr disposed in front of the vehicle A. The target obstacle warning content CTta is superimposed and displayed at a position separated from the risk target obstacle Tr by a certain distance so as not to hide the risk target obstacle Tr to be superimposed from the driver's viewpoint.

The target obstacle warning content CTta is an animation display using the base arrow image Pta1 and the emphasis arrow image Pta2 (see the lower part of FIG. 38). The base arrow image Pta1 and the emphasis arrow image Pta2 are V-shaped images indicating the movement direction of the risk target obstacle Tr, similar to the direction presentation image Ptd (see FIG. 37), and are superimposed below the risk target obstacle Tr in the foreground. The base arrow image Pta1 is displayed as a virtual image in white, for example. The emphasis arrow image Pta2 is displayed as a virtual image in warning colors such as yellow and amber, which are more eye-catching than the base arrow image Pta1. The emphasis arrow image Pta2 repeats shift toward the base arrow image Pta1 in accordance with the moving direction of the risk target obstacle Tr.

When the risk target obstacle Tr is approaching from the right front of the subject vehicle, the display control unit 73 displays the base arrow image Pta1 and the emphasis arrow image Pta2 pointing a left direction in the vicinity of the right edge within the view angle VA (see the bottom of FIG. 38). The display control unit 73 reproduces an animation in which the emphasis arrow image Pta2 displayed on the right side of the base arrow image Pta1 is repeatedly shifted leftward. On the other hand, when the risk target obstacle Tr is approaching from the left front of the subject vehicle, the display control unit 73 displays the base arrow image Pta1 and the emphasis arrow image Pta2 pointing to the right direction in the vicinity of the left edge within the view angle VA. The display control unit 73 reproduces an animation in which the emphasis arrow image Pta2 displayed on the left side of the base arrow image Pta1 is repeatedly shifted rightward.

he display control unit 73 terminates the display of the target obstacle warning content CTta at the timing when the risk target obstacle Tr reaches approximately the center of the view angle VA so as not to hinder the driver's direct visual recognition of the risky target obstacle Tr. After hiding the target obstacle warning content CTta, the display control unit 73 shifts the view angle VA from the superimposed position VP2 to the normal position VP1. As described above, the forward target obstacle warning is terminated.

<Parking Space Guidance>

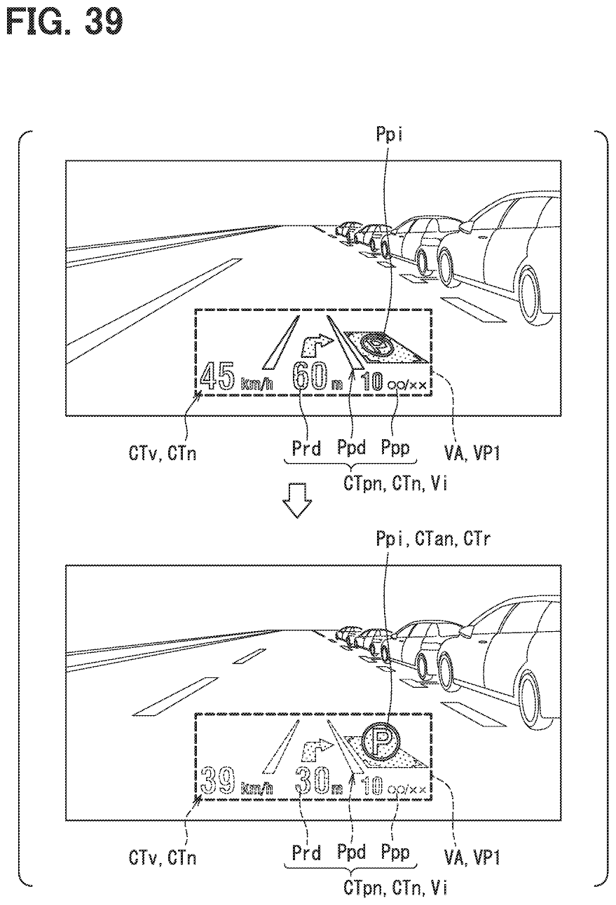

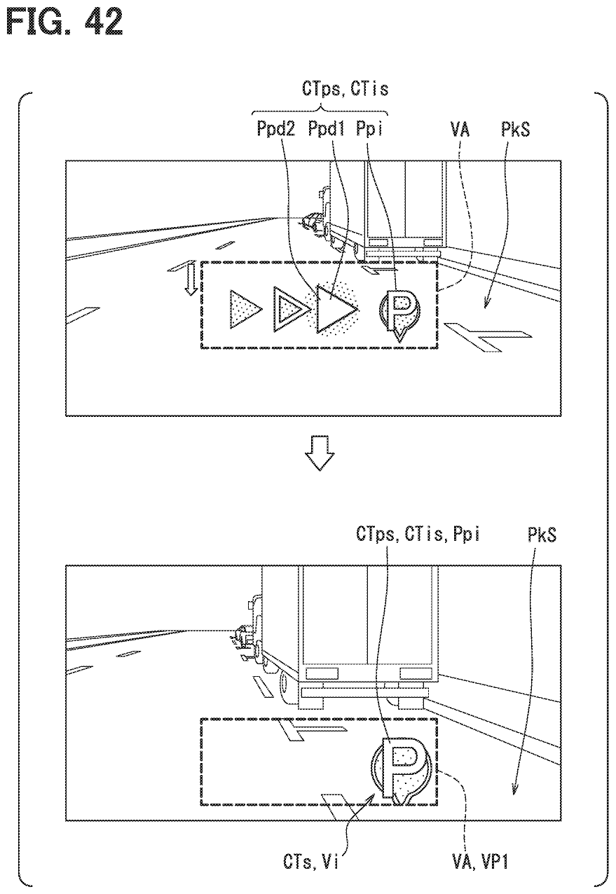

In the parking space guidance shown in FIGS. 39 to 42, the driver is guided to an empty parking space PkS (see FIG. 42). The parking space guidance is performed as a part of route guidance by the navigation ECU 22, for example. When the destination and the route are set, the navigation ECU 22 inquires of the driver whether or not to reserve a parking space PkS near the destination. The navigation ECU 22 determines to execute the parking space guidance at the end of the route guidance based on the user's operation instructing reservation of the parking space PkS.

The navigation ECU 22 identifies the position of the parking space PkS in which the vehicle A is to be parked based on the parking space information acquired through the in-vehicle communication device 25. The navigation ECU 22 requests the head-up ECU 70 and the meter ECU 32 to start the parking space guidance at the timing when the remaining distance to the specified parking space PkS becomes less than a predetermined guidance start distance (for example, about 100 m). Accurate grasping of the position of the vacant parking space PkS in the parking space guidance may be supported by the driving support ECU 23 that acquires the detection information of the camera ECU 21 or the radar ECU 24.

The display control unit 73 causes the display of the parking guidance content CTpn to start when the information acquisition unit 71 acquires the execution request of the parking space guidance as a trigger (see the upper part of FIG. 39). The parking guidance content CTpn is displayed within the view angle VA at the normal position VP1 together with the speedometer CTv. The parking guidance content CTpn is the non-superimposed content CTn and includes a remaining distance image Prd, a fee image Ppp, and a direction guidance image Ppd.

The remaining distance image Prd is an image showing the remaining distance to the parking space PkS. The fee image Ppp is an image that notifies the fee for using the parking space PkS. The parking fee information presented by the fee image Ppp may be included in the parking space information, or may be stored in advance in a map database referred to by the navigation ECU 22. The direction guide image Ppd is an image indicating on which side of the vehicle the parking space PkS is located, i.e., a left side or a right side. The direction guide image Ppd includes a parking icon Ppi including the letter “P”. The parking icon Ppi is drawn in an attitude inclined toward the back as seen from the driver, and is displayed in such a manner as to stick to the road surface ahead.

The display control unit 73 continues displaying the parking guidance content CTpn until the remaining distance to the parking space PkS becomes less than a predetermined approach distance (for example, about 30 m). The display control unit 73 starts displaying the approach notification content CTan at the timing when the remaining distance becomes less than the approach distance (see the lower part of FIG. 39). The approach notification content CTan is displayed as the related content CTr in parking space guidance, and notifies the approach of the parking space PkS. The display control unit 73 displays, as the approach notification content CTan, an animation that causes the parking icon Ppi to be vertical to the road surface.

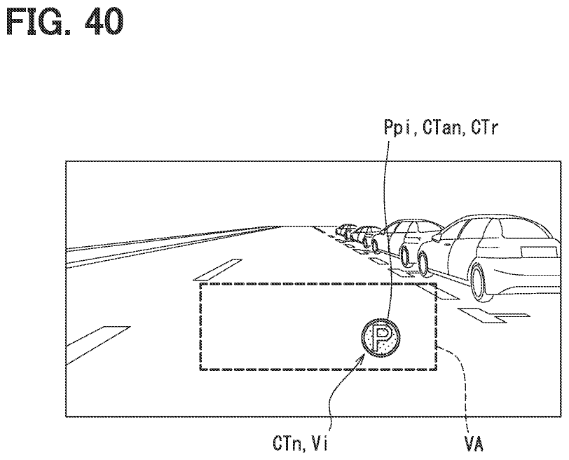

The display control unit 73 tones down each image of the parking guidance content CTpn except for the parking icon Ppi and the speedometer CTv in accordance with the start of display of the approach notification content CTan. The display control unit 73 hides the images of the parking guidance content CTpn and the speedometer CTv by toning down, and displays only the parking icon Ppi (see FIG. 40). The parking icon Ppi emits strong light once and then disappears toward the parking space PkS.

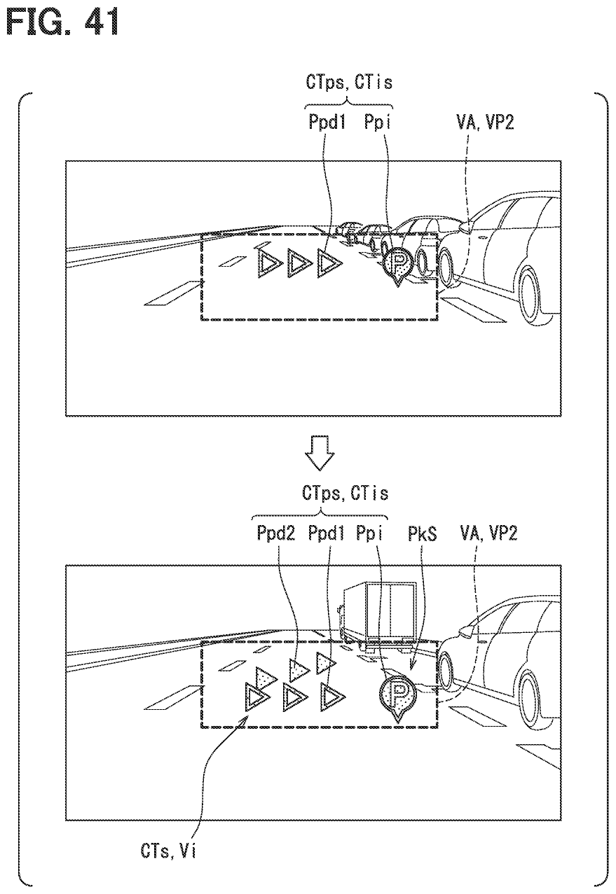

After hiding the parking icon Ppi, the display control unit 73 starts shifting the view angle VA from the normal position VP1 to the superimposed position VP2. After completing the shift of the view angle VA to the superimposed position VP2, the display control unit 73 starts displaying the parking guidance content CTps (see the upper part of FIG. 41). The parking guidance content CTps is a specific content CTis for parking space guidance, and is a superimposed content CTs with a front road surface as a superimposed target object.

The parking guidance content CTps includes a parking icon Ppi and direction guidance images Ppd1 and Ppd2. The parking icon Ppi fades into the view angle VA from the direction of the parking space PkS and is redisplayed within the view angle VA. The parking icon Ppi is displayed near the left and right edges within the view angle VA on the side where the parking space PkS exists. The parking icon Ppi is displayed like a signboard erected on the ground.

The direction guide image Ppd1 is displayed in the approximate center of the view angle VA so as to be aligned with the parking icon Ppi in the right-left direction. The direction guide image Ppd1 includes a plurality of (three) triangular image portions pointing in the direction of the parking icon Ppi. The direction guide image Ppd1 starts to be displayed together with the parking icon Ppi, and shifts downward within the view angle VA along with the parking icon Ppi as the parking space PkS approaches.

The direction guide image Ppd2 starts to be displayed at the timing when a part of the parking space PkS enters the view angle VA (see the lower part of FIG. 41). The direction guide image Ppd2 is displayed above the direction guide image Ppd1 so as to be perceived on the far side of the direction guide image Ppd1. Similar to the direction guide image Ppd1, the direction guide image Ppd2 includes a plurality of (three) triangular image portions and indicates the direction of the parking space PkS.

The display control unit 73 shifts the direction guide image Ppd2 downward as the vehicle A travels. As a result, each image portion of the direction guide image Ppd2 collides with each image portion of the direction guide image Ppd1 in order (see the upper part of FIG. 42). The direction guidance images Ppd1 and Ppd2 are hidden by sequentially causing the image portions that collide with each other to emit light and disappear. As a result, only the parking icon Ppi is displayed as the parking guidance content CTps.

The display control unit 73 starts shifting the view angle VA from the superimposed position VP2 to the normal position VP1 while continuing to display the parking guidance content CTps (i.e., the specific content CTis). The display control unit 73 shifts the view angle VA downward as the vehicle A travels, in other words, as the parking space PkS approaches the driver apparently. As a result, the parking icon Ppi continues to be superimposed in the vicinity of the parking space PkS. At the timing when the vehicle A enters the parking space PkS, the display control unit 73 changes the parking icon Ppi so that it is apparently buried in the ground (see the lower part of FIG. 42), and notifies the driver that the vehicle A has arrived at the parking space PkS as the destination. After the vehicle A arrives at the parking space PkS, the display control unit 73 hides the parking icon Ppi at the timing when the parking space PkS is outside the view angle VA. Thus, the parking space guidance is completed.

<Narrow Road Driving Support Display>

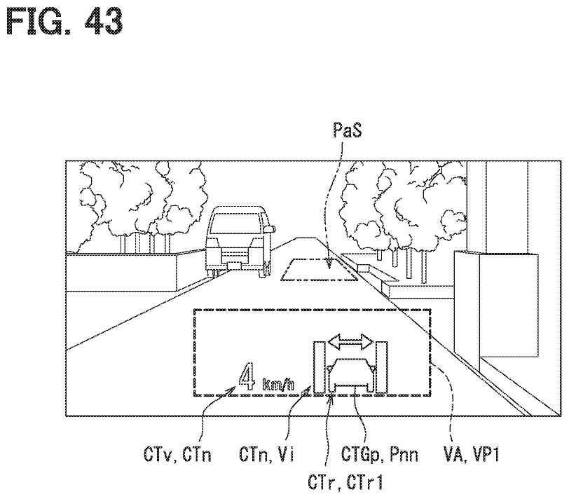

The narrow road driving support display shown in FIGS. 43 to 46 is performed in a narrow road driving scene in which the vehicle A is traveling on a narrow road, and supports the driver's steering operation. The narrow road is a running space PaS (see FIG. 43) that is slightly wider than the full width of vehicle A. A narrow road may be a road with a narrow width, or may be a drivable area between a vehicle parked on the road and a road shoulder. The driving support ECU 23 diagnoses whether or not the running space PaS in front of the vehicle corresponds to a narrow road based on detection information from the camera ECU 21 or the radar ECU 24. When the driving support ECU 23 diagnoses that there is a narrow road ahead of the vehicle, the driving support ECU 23 determines to execute the narrow road driving support display, and requests the head-up ECU 70 and the meter ECU 32 to start the narrow road driving support display.

The road width of the running space PaS to be diagnosed as a narrow road may be automatically changed according to the driving skill of the driver. The driving assistance ECU 23 narrows the road width for determining the execution of the narrow road driving support display for a driver with higher driving skill. In addition, the driving support ECU 23 may determine to perform the narrow road driving support display based on the user's operation input by the driver. Further, when the driving support ECU 23 determines that the width of the road in front of the vehicle is about the same as or narrower than the width of the vehicle, i.e., when it is determined that the vehicle cannot pass through substantially, the narrow road driving support display is not executed.

The display control unit 73 causes the display of the guidance content CTGp to start when the information acquisition unit 71 acquires a request to execute the narrow road driving support display as a trigger. The guidance content CTGp is the related content CTr in narrow road driving support display. The display control unit 73 sequentially displays the narrow road notification image Pnn and the narrow road emphasis image Pen as the guidance content CTGp in turn.

The narrow road notification image Pnn is displayed as the first related content CTr1 in an arrangement aligned with the speedometer CTv within the view angle VA of the normal position VP1 (see FIG. 43). The narrow road notification image Pnn is the non-superimposed content CTn whose display shape and display position within the view angle VA are defined in advance. The narrow road notification image Pnn notifies the driver that there is a narrow road ahead of the vehicle and indicates to the driver that the vehicle A can pass through the narrow road ahead.

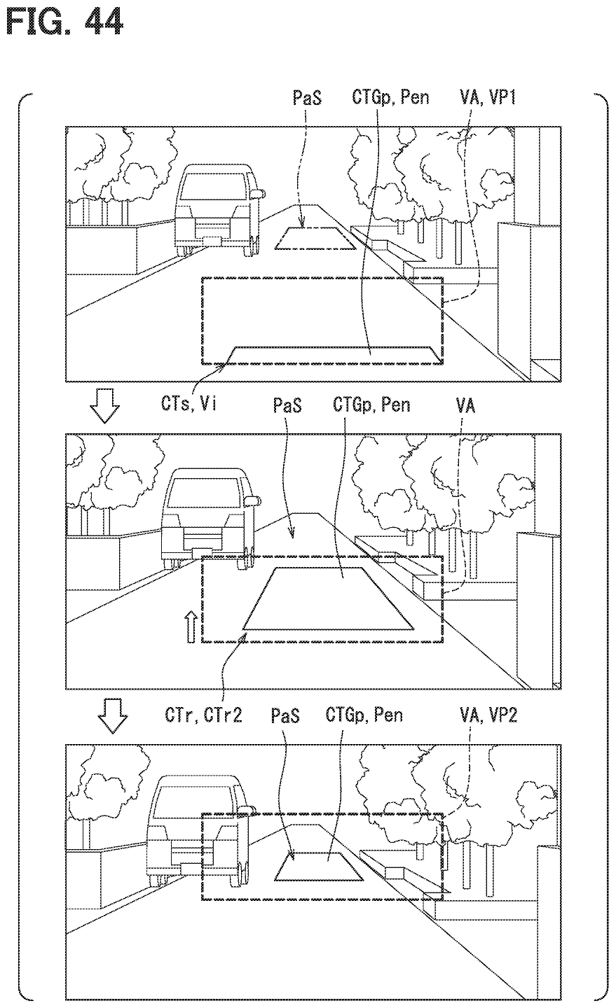

Before starting to shift the view angle VA at time t1 (see FIG. 4), the display control unit 73 hides the narrow road notification image Pnn and the speedometer CTv, and then displays the narrow road emphasis image Pen as the second related content CTr2 (see the upper part of FIG. 44). The narrow road emphasis image Pen is the related content CTr in a different manner from the narrow road notification image Pnn. The display control unit 73 starts displaying the narrow road emphasis image Pen before the shift of the view angle VA from the normal position VP1 to the superimposed position VP2 is started, and continues to display the narrow road-enhanced image Pen until the shift of the view angle VA to the superimposed position VP2 is completed.

While the view angle VA is at the normal position VP1, the display control unit 73 displays the narrow road emphasis image Pen having the horizontally long shape that extends in the right left direction while being in contact with the lower edge of the view angle VA (see the upper part of FIG. 44). The narrow road emphasis image Pen is the superimposed content CTs that is superimposed on the road surface in front of the vehicle. The length of the narrow road emphasis image Pen in the right-left direction is adjusted according to the road width of the traveling space PaS in front of the vehicle.

The display control unit 73 expands the narrow road emphasis image Pen in the up down direction in accordance with the upward shift of the view angle VA (during the shift period TM1, see FIG. 4) (see middle of FIG. 44). As a result, the narrow road emphasis image Pen is drawn in a trapezoidal shape that is tilted toward the back when viewed from the driver, and is displayed in a state that the image sticks to the road surface ahead. The narrow road emphasis image Pen guides the line of sight of the driver to the driving space PaS by shifting toward the driving space PaS in the foreground as the guidance content CTGp. At time t2 (see FIG. 4) when the shift of the view angle VA to the superimposed position VP2 is completed, the narrow road-emphasis image Pen is superimposed on the running space PaS and appears to cover the entire running space PaS (see the bottom of FIG. 44).

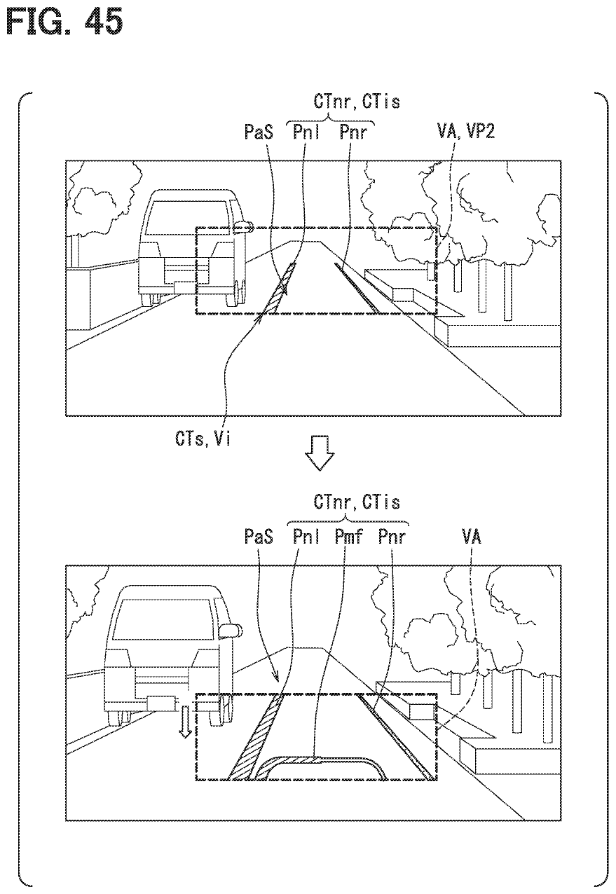

After completing the shift of the view angle VA to the superimposed position VP2, the display control unit 73 ends the display of the narrow road emphasis image Pen (as the guidance content CTGp) and starts the display of the narrow road driving support content CTnr (see the upper part of FIG. 45). The narrow road driving support content CTnr is the specific content CTis in the narrow road driving support display, and is the superimposed content CTs that uses the driving space PaS as the superimposed object, similar to the narrow road emphasis image Pen. The display control unit 73 displays the left boundary image Pnl and the right boundary image Pnr as the narrow road driving support content CTnr within the view angle VA at the superimposed position VP2.

The left boundary image Pnl is a linear image superimposed on the left boundary of the running space PaS. The right boundary image Pnr is a linear image superimposed on the right boundary of the running space PaS. The left boundary image Pnl and the right boundary image Pnr show the driver the road surface range that will be the running space PaS. The display control unit 73 changes the display colors of the left boundary image Pnl and the right boundary image Pnr according to the size of the space distance in the horizontal direction secured between each boundary in the running space PaS and the vehicle A if the subject vehicle maintains to go straight. Specifically, the display control unit 73 displays the left boundary image Pnl and the right boundary image Pnr in white, blue, or the like when the space between the boundary and the vehicle A is secured. On the other hand, when the distance between the boundary and the vehicle A is not sufficient and falls below a certain value, the display control unit 73 displays the left boundary image Pnl and the right boundary image Pnr in yellow, amber, or the like.

When the vehicle A approaches the running space PaS, the display control unit 73 starts shifting the view angle VA from the superimposed position VP2 to the normal position VP1 while continuing to display the narrow road driving support content CTnr (as the specific content CTis). The display control unit 73 shifts the view angle VA downward as the vehicle A travels, in other words, as the running space PaS approaches the driver apparently. The display control unit 73 adds the subject vehicle position image Pmf to the narrow road driving support content CTnr during the downward shift of the view angle VA (i.e., during the shift period TM2, see FIG. 4) (see the lower part of FIG. 45).

The subject vehicle position image Pmf is an image showing the future position of the vehicle A. The subject vehicle position image Pmf has a horizontally long shape reminiscent of the front bumper of the vehicle A, and is displayed in the vicinity of the lower edge within the view angle VA with a display width corresponding to the vehicle width of the subject vehicle. The vehicle position image Pmf is displayed between the left boundary image Pnl and the right boundary image Pnr to visually indicate the ratio between the width of the running space PaS and the width of the vehicle. The host vehicle position image Pmf shifts left and right between the left boundary image Pnl and the right boundary image Pnr according to the driver's steering operation. When the traveling position of the vehicle A is too close to the left side of the traveling space PaS, the left end portion of the vehicle position image Pmf and the left boundary image Pnl change to a warning color, prompting the driver to steer to the right. On the other hand, when the traveling position of the vehicle A is too close to the right side of the traveling space PaS, the right end portion of the vehicle position image Pmf and the right boundary image Pnr change to a warning color, to prompt the driver to execute the steering operation to the left. With the display changes described above, the narrow road driving support content CTnr supports the driver in driving on the narrow road.

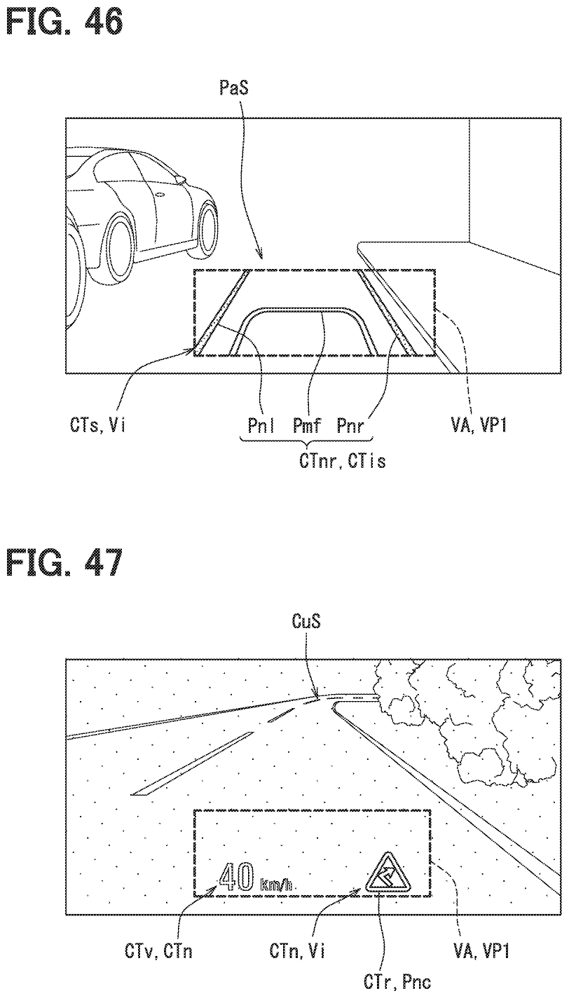

The display control unit 73 continues to display the narrow road driving support content CTnr even after time t4 (see FIG. 4) when the shift of the view angle VA to the normal position VP1 is completed (see FIG. 46). As a result, even while the vehicle A travels in the running space PaS, the narrow road driving support content CTnr continues to support the narrow road driving operation. The display control unit 73 hides the narrow road driving support content CTnr at the timing when the vehicle A passes through the driving space PaS and the driving space PaS is outside the view angle VA as seen by the driver. As described above, the narrow road driving support display ends.

<Visibility Support Display>

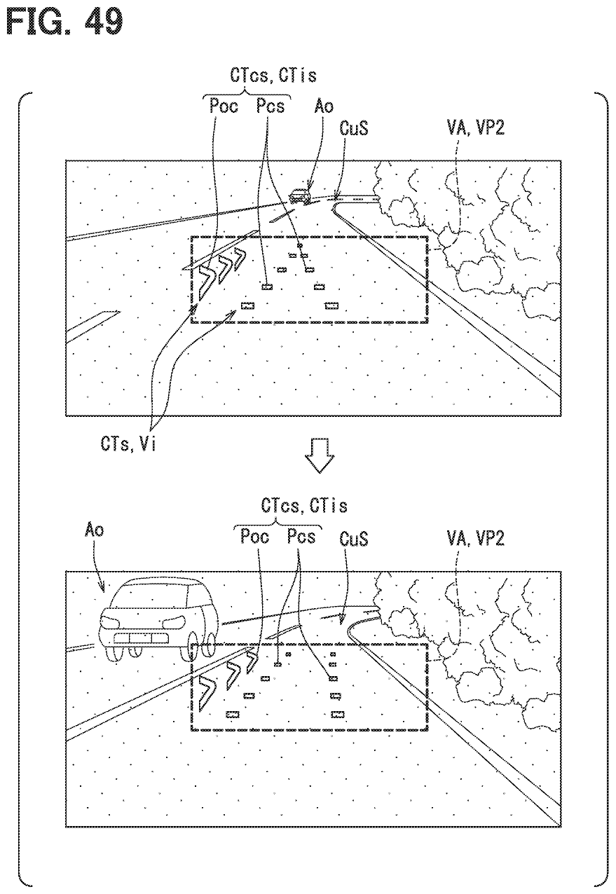

The visibility support display shown in FIGS. 47 to 50 is performed in an environment of poor visibility such as fog or heavy rain, and supports the driver to drive the vehicle A in the curve section CuS (see FIG. 49) ahead. The driving support ECU 23 determines whether the visibility in front of the vehicle is poor based on the information detected by the camera ECU 21. When the driving support ECU 23 determines that the visibility in front of the vehicle is poor, it further determines whether the running speed of the vehicle A exceeds a threshold value (for example, 30 km/h) and whether there is a curve section CuS ahead of the vehicle. The information (i.e., the map data) indicating the shape of the road in front of the vehicle may be acquired from the network outside the vehicle through the in-vehicle communication device 25 or may be acquired from the navigation ECU 22. When the vehicle A traveling at a speed exceeding the threshold approaches the curve section CuS in an environment of poor visibility, the driving support ECU 23 determines to perform the visibility support display, and requires the head-up ECU 70, the meter ECU 32 and the like to start the visibility support display. Based on the information detected by the camera ECU 21, the driving support ECU 23 notifies the head-up ECU 70, the meter ECU 32, and the like of the end of the visibility support display when diagnosing that a certain distance can be seen.

The display control unit 73 causes the display of the curve notification image Pnc to start when the information acquisition unit 71 acquires the execution request of the visibility support display (see FIG. 47). The curve notification image Pnc is a non-superim posed content CTn displayed near the lower edge of the view angle VA so as to be arranged side by side with the speedometer CTv in the right left direction. The curve notification image Pnc is displayed as the related content CTr in the visibility support display. The curve notification image Pnc is displayed as a virtual image in a warning color such as yellow. The curve notification image Pnc alerts the driver that a curve section CuS with a large curvature is approaching ahead of the vehicle. The curve notification image Pnc is an image mainly including a curved or bending arrow so as to remind one of a curve.

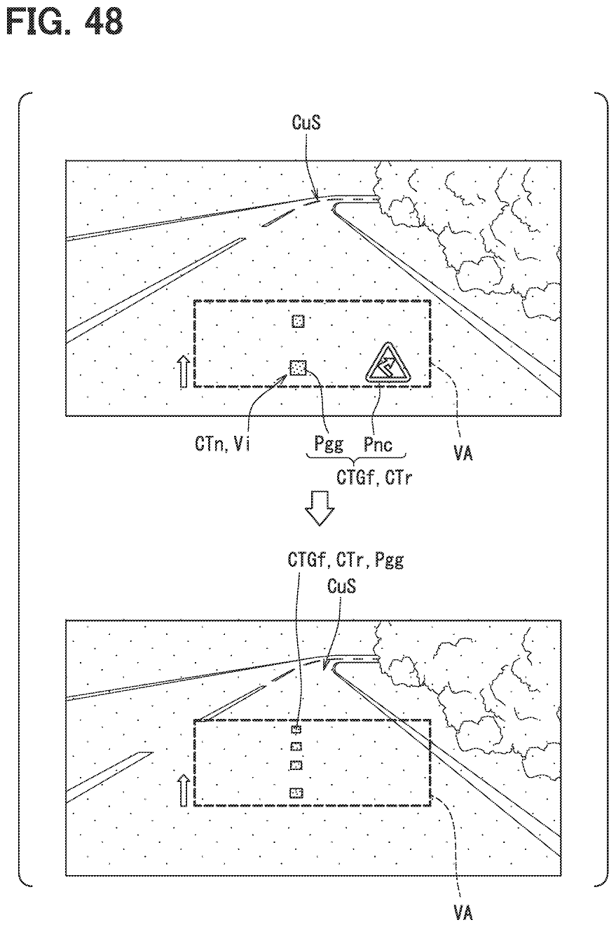

Before the shift of the view angle VA is started at time t1 (see FIG. 4), the display control unit 73 causes the visual guidance image Pgg to be displayed at the center of the view angle VA instead of the speedometer CTv (see an upper part of FIG. 48). The visual guidance image Pgg is an image including a plurality of light emitting spots. A plurality of light-emitting spots are displayed as virtual images in white, blue, or the like, for example. The light-emitting spots are displayed so as to be spaced apart from each other and arranged substantially linearly along the travelling lane of the vehicle in which the vehicle is running. The visual guidance image Pgg may be a non-superimposed content CTn whose display position within the view angle VA is preset, or may be a superimposed content CTs whose alignment direction changes according to the shape of the road in front of the vehicle.

The display control unit 73 uses the curve notification image Pnc and the visual guidance image Pgg as the guidance content CTGf. The guidance content CTGf is a display object for directing the driver's line of sight far away by shifting toward the vanishing point in the foreground during the shift of the view angle VA (i.e., during the shift period TM1, see FIG. 4). The guidance content CTGf guides the driver's attention to the front range where the curve section CuS exists.

The display control unit 73 reduces the display size of the curve notification image Pnc in accordance with the upward shift of the view angle VA. The display control unit 73 ends the display of the curve notification image Pnc (see the lower part of FIG. 48) in the middle of the shift period TM1 (see FIG. 4) of the view angle VA. As described above, the curve notification image Pnc is displayed so as to shift toward the vanishing point in the foreground and disappear.

The display control unit 73 increases the number of light emitting spots of the visual guidance image Pgg in accordance with the upward shift of the view angle VA. The display control unit 73 reduces the display size of the light-emitting spots that are displayed upward. The display control unit 73 continues to display the visual guide image Pgg even after the curve notification image Pnc is hidden (see the lower part of FIG. 48) to guide the driver's attention far away.

The display control unit 73 continues to display the visual guide image Pgg until the shift of the view angle VA to the superimposed position VP2 is completed at time t2 (see FIG. 4). The display control unit 73 starts the display of the curve guidance content CTcs by animation display in which the plurality of light emitting spots of the visual guide image Pgg are divided into left and right (see the upper part of FIG. 49). The curve guidance content CTcs is the specific content CTis in the visibility support display. The curve guidance content CTcs is the superimposed content CTs on which the road surface of the subject vehicle lane in the foreground is the superimposed target object, and is superimposed on the road surface to show the driver the shape of the road ahead.

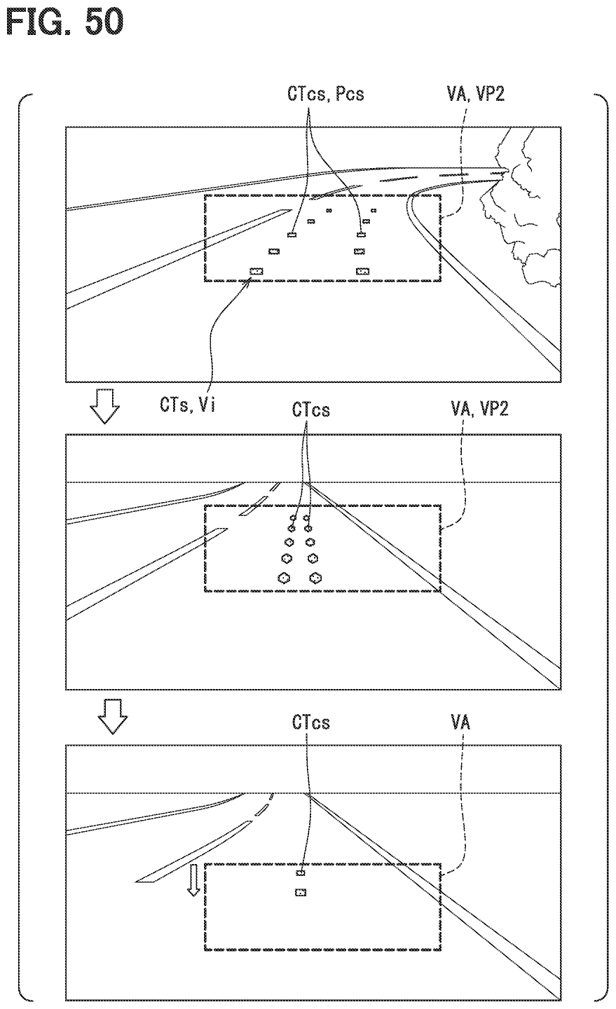

The curve guidance content CTcs is the superimposed content CTs including a curve shape image Pcs and an oncoming vehicle notification image Poc. The curve shape image Pcs is an image including a plurality of left and right split light emitting spots. The curve shape image Pcs has two left and right rows of light emitting spots aligned along the road ahead, and guides the driver to the shape of the road ahead of the vehicle. The oncoming vehicle notification image Poc is displayed when the driving support ECU 23 detects an oncoming vehicle Ao (see FIG. 49) traveling in the opposite lane. The oncoming vehicle notification image Poc is an image that prompts the driver's attention to the existence of the oncoming vehicle Ao approaching from the front, and is displayed as a virtual image in a warning color such as yellow, for example. The oncoming vehicle notification image Poc is displayed on the opposite lane side with respect to the curve shape image Pcs. The oncoming vehicle notification image Poc has a plurality of V-shaped image portions that are visually recognized in a posture perpendicular to the front road surface, and prevents the vehicle from deviating into the opposite lane. The display of the oncoming vehicle notification image Poc ends when the oncoming vehicle Ao passes by the side of the vehicle A (see the upper part of FIG. 50).

The display control unit 73 terminates the display of the curve guidance content CTcs so as not to interfere with the actual visual recognition of the foreground, triggered by the acquisition of the visibility support display end notification by the information acquisition unit 71. The display control unit 73 shifts the two rows of light emitting spots displayed as the curve shape image Pcs to the center of the view angle VA before time t3 (see FIG. 4) at which the view angle VA starts to shift to the normal position VP1 (see middle of FIG. 50). The display control unit 73 merges the left and right light emitting spots to display one line, and then starts shifting the view angle VA to the normal position VP1. As the view angle VA shifts downward, each light emitting spot shifts out of the view angle VA, and the visibility support display ends (see the lower part of FIG. 50).

The third embodiment described so far has the same effect as the first embodiment, and the display of the related content CTr makes it difficult for the driver to perceive the time lag until the start of display due to the shift of the view angle. Therefore, even if the view angle VA at which the virtual image can be displayed is expanded, the discomfort of the display is reduced, so that the convenience of the HUD 100 can be enhanced.

In addition, in the third embodiment, when the target obstacle warning content CTta that warns of the risk target obstacle Tr in front of the vehicle is displayed as the specific content CTis, the guidance content CTGt that shifts toward the risk target obstacle Tr is displayed as the related content CTr. Such guiding content CTGt can direct the driver's attention to the risk target obstacle Tr or its vicinity at an early stage. As a result, the driver can easily recognize the risk target obstacle Tr and can smoothly take an action with respect to the risk target obstacle Tr. Therefore, highly convenient virtual image display is realized.

Further, in the third embodiment, when the parking guidance content CTps for guiding the parking space PkS in front of the vehicle is displayed as the specific content CTis, the approach notification content CTan for notifying the approach of the parking space PkS is displayed as the related content CTr. Such approach notification content CTan can prompt the driver to perform a driving operation such as deceleration for parking in the parking space PkS. As a result, the driver can smoothly start the driving operation to park the vehicle A in the parking space PkS according to the parking guidance content CTps.

Furthermore, in the third embodiment, when the narrow road driving support content CTnr that supports driving in the driving space PaS is displayed as the specific content CTis, the guide content CTGp that moves toward the driving space PaS is displayed as the related content CTr. Such guide content CTGp can make the driver's attention be directed to the driving space PaS, which is a narrow road, at an early stage. As a result, the driver can smoothly enter the vehicle A into the running space PaS, and can quickly pass through the narrow road in combination with the driving support by the narrow road driving support content CTnr in the narrow road.

In addition, in the third embodiment, when the curve guidance content CTcs indicating the shape of the road in front of the vehicle is displayed as the specific content CTis, the guide content CTGf moving toward the vanishing point in the foreground is displayed as the related content CTr. Such guide content CTGf can direct the driver's attention further away and prompt the driver to act in preparation for traveling in the next curve section CuS. As a result, the driver can decelerate appropriately before entering the curve section CuS even in a scene with poor visibility, for example, and can continue smooth driving in the curve section CuS according to the curve guidance content CTcs.

In the third embodiment, the guide content CTGt corresponds to the “target obstacle guidance content”, and the guide content CTGp corresponds to the “narrow road guidance content”. Also, the curve guidance content CTcs corresponds to the “shape guidance content”, and the guide content CTGp corresponds to the “foreground guidance content”.

(Other Embodiments)

Although a plurality of embodiments according to the present disclosure have been described above, the present disclosure is not construed as being limited to the above-mentioned embodiments, and can be applied to various embodiments and combinations within a scope not departing from the spirit of the present disclosure.

In Modification 1 of the above-described embodiment, the HUD is provided with an actuator as a switching mechanism for shifting the position of the view angle VA in the right left direction Yo (see FIG. 1). Specifically, in Modification 1, a left notification position and a right notification position are defined on the left and right sides of the superimposed position VP2, respectively. The head-up ECU 70 shifts the view angle position from the superimposed position VP2 to the right notification position when displaying the point notification image Ptp (see the lower part of FIG. 23), for example, in the turn-by-turn display at a right-turn intersection. As an example, the head-up ECU 70 starts shifting the view angle at the timing when the vehicle starts turning to the right based on the steering operation. Similarly, in the turn-by-turn display at a left-turn intersection, the head-up ECU 70 shifts the view angle VA from the superimposed position VP2 to the left notification position at the timing when the left turn is started.

As in Modification 1 above, the number of view angle positions that can be set in the HUD may not be limited to the number exemplified in the above embodiment. In addition, the plurality of defined view angle positions may be in a positional relationship in which the boundaries are in contact with each other, may be in a positional relationship in which they are separated from each other, or may be in a positional relationship in which they partially overlap each other. Further, the shifting direction of the view angle VA may not be limited to the up down direction US, and may be the right left direction Yo as in Modification 1, or may be the front-back direction ZG. Furthermore, the view angle shift may be performed by combining each shift in the up-down direction US, the left-right direction Yo, and the front-back direction ZG. The mechanism that enables such view angle shift may also be modified as appropriate.

The content displayed at each view angle position may be appropriately changed between the superimposed content CTs and the non-superimposed content CTn. Similarly, the specific content CTis displayed after the shift of the view angle VA may not be limited to the superimposed content CTs, and may be the non-superimposed content CTn. Further, the specific content CTis may be warning content for notifying the driver of urgent warning information, or may be notification content for notifying the driver of non-urgent status information of the vehicle A. Also, the related content CTr may be either the superimposed content CTs or the non-superimposed content CTn.

In addition, the shape, luminescent color, display position, and the like of the image that becomes each content may be changeable according to the driver's preference. Furthermore, the language and the type of unit may be changed as appropriate based on user settings such as the driver's settings and settings such as the country and region where the vehicle A is used.

In Modified Example 2 of the above-described embodiment, the related content CTr is displayed only before the start of the view angle shift. That is, in Modification 2, the display of the related content CTr during the shift period TM1 from the normal position VP1 to the superimposed position VP2 is omitted. As described above, the display period of the related content CTr may be appropriately changed within the period before the shift to the superimposed position VP2 is completed.

In Modified Example 3 of the above-described embodiment, display change of the meter display device 30 may not be performed in conjunction with shift of the view angle VA by the HUD 100. Specifically, in Modification 3, the toning-down of the detailed information PDi during the shift period TM1 and the display interruption of the detailed information PDi during the display period of the specific content CTis may not be performed.

In Modification 4 of the above-described embodiment, a part or all of the processing functions of the head-up ECU 70 may be implemented in an integrated control device such as an HCU (Human Machine Interface Control Unit). The processing functions of the meter ECU 32 may be further integrated into such an HCU. The HUD may be also the “virtual image display device” in Modification 4 described above.

In 5 of the above embodiment, the detailed information PDi continues to be displayed even during the period when the view angle VA is at the superimposed position VP2. Even after the view angle VA has shifted to the superimposed position VP2, the detailed information PDi continues to be displayed with lower visibility than during the period when the view angle VA is at the normal position VP1. As an example, the detailed information PDi is made to have low luminance or low saturation.

The PGU 61 of the HUD 100 may be provided with an EL (Electro Luminescence) panel instead of the LCD panel and backlight. Also, instead of the EL panel, a PGU 61 using a display device such as a plasma display panel, a cathode ray tube, and an LED may be employed. Furthermore, instead of the LCD panel and backlight, a laser projector or DLP (Digital Light Processing, registered trademark) and a screen may be provided. In the PGU 61 having such a configuration, a display image drawn on the screen is projected onto the windshield WS by the magnifying optical system 62 and formed as a virtual image Vi. In addition, the optical elements employed in the magnifying optical system 62 may not be limited to concave mirrors, and may be appropriately changed to various mirrors, lenses, holographic optical elements, and the like.

The processing units provided in the head-up ECU 70 and the meter ECU 32 of the above embodiment are hardware for arithmetic processing coupled with RAM. The processor includes at least one calculation core, such as a central processing unit (CPU) or a graphics processing unit (GPU). The processing unit may further include an field-programmable gate array(FPGA) and an IP core having other dedicated functions. The RAM may include a video RAM for generating video . The processing unit accesses the RAM to execute various processes for realizing the virtual image display method of the present disclosure. Storage has a configuration that includes a non-volatile storage medium (non-transitory tangible storage medium). Various programs (such as a display control program) executed by the processing unit are stored in the storage of each ECU 32, 70.

In the above embodiments and modifications, the respective functions provided by the head-up ECU 70 and the meter ECU 32 can be also provided by software and hardware for executing the software, only software, only hardware, and complex combinations of software and hardware. In cases where functions are provided by electronic circuits as hardware, the functions can be also provided by analog circuits or digital circuits which include a large number of logic circuits.

Further, the feature of the storage medium for storing the program or the like capable of realizing the above virtual image display method may be changed as appropriate. For example, the storage medium is not limited to the configuration provided on the circuit board, and may be provided in the form of a memory card or the like. The storage medium may be inserted into a slot portion, and electrically connected to the control circuit of the HCU. The storage medium may include an optical disk which forms a source of programs to be copied into a HCU, a hard disk drive therefor, and the like.

The control units and methods thereof described in the present disclosure may be implemented by a special purpose computer which includes a processor programmed to execute one or more functions implemented by computer programs. Alternatively, the control device and method described in the present disclosure may be implemented by a special purpose hardware logic circuit. Alternatively, the control device and the method described in the present disclosure may be implemented by one or more special purpose computers configured by a combination of a processor executing a computer program and one or more hardware logic circuits. The computer program may be stored, as instructions to be executed by a computer, in a tangible non-transitory computer-readable medium.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A virtual image display device for displaying a virtual image that is visually recognizable by an occupant of a vehicle, the virtual image display device comprising:
a switching mechanism for switching a position of a view angle where the virtual image is displayed between a plurality of positions including a first position and a second position; and
a display control unit for displaying the virtual image associated with each of the first position and the second position in response to a switching of the position of the view angle by the switching mechanism, wherein:
when the display control unit displays a specific content within the view angle at the second position after the switching mechanism switches the view angle from the first position to the second position, the display control unit starts displaying a related content preliminarily associated with the specific content before the switching of the view angle to the second position is completed; and
when the display control unit displays a departure warning content that warns the vehicle of departure from a travelling lane in which the vehicle is traveling, as the specific content, the display control unit displays a moving content as the related content that visually shifts when viewing from the occupant in accordance with the switching of the view angle.

2. The virtual image display device according to claim 1, wherein:
when the display control unit displays, as the specific content, a target obstacle warning content for warning of a risk target obstacle that has occurred in front of the vehicle, the display control unit displays, as the related content, a target obstacle guide content shifting toward the risk target obstacle in a foreground of the vehicle while the switching mechanism is switching the view angle.

3. The virtual image display device according to claim 1, wherein:
when the vehicle travels on a narrow road, and the display control unit displays a narrow road driving support content that is superimposed on a road surface in a foreground of the vehicle and supports a driving in a driving space through which the vehicle can pass, the display control unit displays, as the related content, a narrow road guide content that shifts toward the driving space in the foreground of the vehicle while the switching mechanism is switching the view angle.

4. The virtual image display device according to claim 1, wherein:
when the display control unit displays, as the specific content, a shape guide content that is superimposed on a road surface in a foreground of the vehicle and indicates a shape of a road ahead of the vehicle, the display control unit displays, as the related content, a foreground guide content that shifts toward a vanishing point in the foreground of the vehicle while the switching mechanism is switching the view angle.

5. The virtual image display device according to claim 1, wherein:
the display control unit starts displaying the related content before the switching mechanism starts switching the view angle.

6. The virtual image display device according to claim 5, wherein:
the related content displayed before the switching mechanism starts switching the view angle is defined as a first related content; and
the display control unit displays a second related content, which is the related content in a mode different from that of the first related content, while the switching mechanism is switching the view angle.

7. The virtual image display device according to claim 1, wherein:
the display control unit starts displaying the related content while the switching mechanism is switching the view angle.

8. The virtual image display device according to claim 1, wherein:
the second position is disposed above the first position in the switching mechanism; and
the display control unit superimposes and displays the specific content over a target object in a foreground of the vehicle.

9. The virtual image display device according to claim 1, wherein:
when the display control unit displays an inter-vehicle distance notification content for notifying an operating state of an adaptive cruise control as the specific content, the display control unit displays a part of the inter-vehicle distance notification content as the related content within the view angle while the switching mechanism is switching the view angle.

10. The virtual image display device according to claim 1, wherein:
when the display control unit displays, as the specific content, a route guidance content that provides route guidance superimposed on a road surface in a foreground of the vehicle, the display control unit displays a lane emphasis content that emphasizes a travelling lane of the vehicle as the related content.

11. The virtual image display device according to claim 1, wherein:
when the display control unit displays, as the specific content, a parking guidance content for guiding a parking space in front of the vehicle, the display control unit displays an approach notification content for notifying an approach of the parking space as the related content.

12. A virtual image display device for displaying a virtual image that is visually recognizable by an occupant of a vehicle, the virtual image display device comprising:
a switching mechanism for switching a position of a view angle where the virtual image is displayed between a plurality of positions including a first position and a second position; and
a display control unit for displaying the virtual image associated with each of the first position and the second position in response to a switching of the position of the view angle by the switching mechanism, wherein:
when the display control unit displays a specific content within the view angle at the second position after the switching mechanism switches the view angle from the first position to the second position, the display control unit starts displaying a related content preliminarily associated with the specific content before the switching of the view angle to the second position is completed; and
when the display control unit displays a departure warning content that warns the vehicle of departure from a travelling lane in which the vehicle is traveling, as the specific content, the display control unit displays a moving content as the related content that shifts toward a vanishing point in a foreground of the vehicle while the switching mechanism is switching the view angle.

13. A virtual image display device for displaying a virtual image that is visually recognizable by an occupant of a vehicle, the virtual image display device comprising:
a switching mechanism for switching a position of a view angle where the virtual image is displayed between a plurality of positions including a first position and a second position; and
a display control unit for displaying the virtual image associated with each of the first position and the second position in response to a switching of the position of the view angle by the switching mechanism, wherein:
when the display control unit displays a specific content within the view angle at the second position after the switching mechanism switches the view angle from the first position to the second position, the display control unit starts displaying a related content preliminarily associated with the specific content before the switching of the view angle to the second position is completed; and
when the display control unit displays, as the specific content, a target obstacle warning content for warning of a risk target obstacle that has occurred in front of the vehicle, the display control unit displays, as the related content, a target obstacle guide content shifting toward the risk target obstacle in a foreground of the vehicle while the switching mechanism is switching the view angle.

14. A virtual image display device for displaying a virtual image that is visually recognizable by an occupant of a vehicle, the virtual image display device comprising:
a switching mechanism for switching a position of a view angle where the virtual image is displayed between a plurality of positions including a first position and a second position; and
a display control unit for displaying the virtual image associated with each of the first position and the second position in response to a switching of the position of the view angle by the switching mechanism, wherein:
when the display control unit displays a specific content within the view angle at the second position after the switching mechanism switches the view angle from the first position to the second position, the display control unit starts displaying a related content preliminarily associated with the specific content before the switching of the view angle to the second position is completed; and
when the vehicle travels on a narrow road, and the display control unit displays a narrow road driving support content that is superimposed on a road surface in a foreground of the vehicle and supports a driving in a driving space through which the vehicle can pass, the display control unit displays, as the related content, a narrow road guide content that shifts toward the driving space in the foreground of the vehicle while the switching mechanism is switching the view angle.

15. A virtual image display device for displaying a virtual image that is visually recognizable by an occupant of a vehicle, the virtual image display device comprising:
a switching mechanism for switching a position of a view angle where the virtual image is displayed between a plurality of positions including a first position and a second position; and
a display control unit for displaying the virtual image associated with each of the first position and the second position in response to a switching of the position of the view angle by the switching mechanism, wherein:
when the display control unit displays a specific content within the view angle at the second position after the switching mechanism switches the view angle from the first position to the second position, the display control unit starts displaying a related content preliminarily associated with the specific content before the switching of the view angle to the second position is completed; and
when the display control unit displays, as the specific content, a shape guide content that is superimposed on a road surface in a foreground of the vehicle and indicates a shape of a road ahead of the vehicle, the display control unit displays, as the related content, a foreground guide content that shifts toward a vanishing point in the foreground of the vehicle while the switching mechanism is switching the view angle.

16. A virtual image display device for displaying a virtual image that is visually recognizable by an occupant of a vehicle, the virtual image display device comprising:
a switching mechanism for switching a position of a view angle where the virtual image is displayed between a plurality of positions including a first position and a second position; and
a display control unit for displaying the virtual image associated with each of the first position and the second position in response to a switching of the position of the view angle by the switching mechanism, wherein:
when the display control unit displays a specific content within the view angle at the second position after the switching mechanism switches the view angle from the first position to the second position, the display control unit starts displaying a related content preliminarily associated with the specific content before the switching of the view angle to the second position is completed; and
the related content displayed before the switching mechanism starts switching the view angle is defined as a first related content; and
the display control unit displays a second related content, which is the related content in a mode different from that of the first related content, while the switching mechanism is switching the view angle.

17. A display system comprising:
the virtual image display device according to claim 1; and
a screen display device that changes a display on a display screen in cooperation with switching of the position of the view angle by the switching mechanism.

18. The display system according to claim 17, wherein:
the screen display device displays detailed information related to the specific content on the display screen during a period in which the view angle is disposed at the first position; and
when the switching of the view angle from the first position to the second position is completed, the screen display device reduces a visibility of the detailed information or hides the detailed information, compared with the period in which the view angle is disposed at the first position.

19. The display system according to claim 18, wherein:
the screen display device performs a mode change for reducing the visibility of the detailed information during a switching period during which the view angle is switched from the first position to the second position.
